(19) United States
(12) Patent Application Publication
(10) Pub. No.: US 2013/0333051 A1
(43) Pub. Date: Dec. 12, 2013

(54) RANDOM VALUE IDENTIFICATION DEVICE, RANDOM VALUE IDENTIFICATION SYSTEM, AND RANDOM VALUE IDENTIFICATION METHOD

(71) Applicant: Takao Takenouchi, Tokyo (JP)

(72) Inventor: Takao Takenouchi, Tokyo (JP)

(73) Assignee: NEC CORPORATION, Tokyo (JP)

(21) Appl. No.: 14/001,234

(22) PCT Filed: Feb. 17, 2012
(86) PCT No.: PCT/JP2012/054487

§ 371 Date: Aug. 23, 2013

(30) Foreign Application Priority Data
Mar. 4, 2011 (JP) 2011-047928

(51) Int. Cl. G06F 21/60

(52) U.S. Cl. CPC G06F 21/60
USPC 726/26

(57) ABSTRACT

When concealing the value of original data by adding a random value to the value of the original data, this random value identification device acquires a user identifier and an attribute name of an attribute of information relating to a user, identifies the correlation between the attributes indicated by the attribute name, acquires at least one attribute value of the attributes of the user identified by the user identifier, and generates a random number for each attribute within a random value range identified on the basis of the identified correlation and the acquired attribute value.

### FIELD OF THE INVENTION

The present invention relates to a technology which identifies a random value for concealing a value of original data.

### BACKGROUND OF THE INVENTION

A technology for concealing a value of original data by adding a random value (random number value) to the value of the original data is known.

For example, the technology disclosed in patent document 1 converts the original data in disturbance data by using a process including a random step. Then, the technology performs a statistical process in which the effect of the random step is eliminated based on the disturbance data.

And, a technology described in non-patent document 1 generates the disturbance data by adding a random noise (random number) to the original data based on a correlation of an attribute value between predetermined attributes. Then, the technology performs a statistical process based on the disturbance data.
[Patent document 1] Japanese Patent Application Laid-Open No. 2007-288480
[Non-patent document 1] Zhengli Huang et al., “Deriving Private Information from Randomized Data,” In Proc. of the ACM SIGMOD, pages 37-48, 2005.

### SUMMARY OF THE INVENTION

### Problems to be Solved by the Invention

The technologies described in patent document 1 and non-patent document 1 remove the influence of the random data by performing the statistical process using a plurality of disturbance data. Therefore, in the technologies described in patent document 1 and non-patent document 1, the value of each disturbance data is greatly different from the value of the original data, and data which has a value that is essentially not taken by the original data is included in the disturbance data. As for such each disturbance data, the validity of data is spoiled. Accordingly, the technologies described in patent document 1 and non-patent document 1 can not identify an appropriate random value that can conceal the value of the original data and increase the validity of the data after adding the random value.

One of the objects of the present invention is to provide a random value identification device, a random value identification system, and a random value identification method which identify an appropriate random value that can conceal a value of original data and increase a validity of data after adding a random value.

### Means for Solving the Problem

A first random value identification device according to one configuration of the present invention includes: reception means for receiving a user identifier and an attribute name of an attribute of information related to the user; correlation identification means for identifying a correlation of the attribute indicated by the attribute name; attribute value acquisition means for acquiring at least one attribute value of the attribute of the user identified by the user identifier; and random number generation means for generating a random number for each the attribute in a random value range identified based on the acquired attribute value and the identified correlation.

A first random value identification system according to one configuration of the present invention includes: a search provider device; an information storing provider device; and a random value identification device; wherein the search provider device includes: query transmission means for transmitting a user identifier and an attribute name of an attribute of information related to a user to the information storing provider device; the information storing provider device includes: reception means for receiving the user identifier and the attribute name from the search provider device; attribute value storage means for storing the user identifier, the attribute name, and an attribute value so that they are associated; attribute value acquisition means for acquiring the attribute value associated with the user identifier and the attribute name from the attribute value storage means; transmission means for transmitting the user identifier, the attribute name, and the attribute value to the random value identification device; and random number addition means for receiving the random value from the random value identification device for each attribute, acquiring the attribute value associated with the user identifier and the attribute name indicating the attribute that are received by the reception means from the attribute value storage means, and adding the random number to the attribute value; and the random value identification device includes: reception means for receiving the user identifier, the attribute name, and the attribute value from the information storing provider device; permission information storage means for storing the user identifier with permission information indicating the attribute of which the user identified by the user identifier permits a disclosure so that they are associated; search estimation means for reading the permission information associated with the user identifier from the permission information storage means based on the user identifier received by the reception means, and identifying at least one attribute from the attributes indicated by the read permission information; correlation identification means for identifying the correlation between the identified attribute and the attribute indicated by the attribute name received by the reception means; random number generation means for generating the random number for each the attribute in a random value range identified based on at least one attribute value among the attribute values received by the reception means and the identified correlation; and random number transmission means for transmitting the random number to the information storing provider device.

A first random value identification method according to one configuration of the present invention includes: receiving a user identifier and an attribute name of an attribute of information related to the user; identifying a correlation between the attributes; acquiring at least one attribute value of the attribute of the user identified by the user identifier; and generating a random number for each the attribute in a random value range identified based on the acquired attribute value and the identified correlation.

A second random value identification method according to one configuration of the present invention includes: a search provider device transmits a user identifier and an attribute name of an attribute of information related to the user to an information storing provider device; the information storing provider device receives the user identifier and the attribute name from the search provider device, stores the user identifier by which the user can be identified, the attribute name, and an attribute value so that they are associated in attribute value storage means, acquires the attribute value associated with the user identifier and the attribute name from the attribute value storage means, transmits the user identifier, the attribute name, and the attribute value to the random value identification device, receives the random value from the random value identification device for each attribute, acquires the attribute value associated with the user identifier received from the attribute value storage means by the reception means and the attribute name received by the reception means, adds the random number to the attribute value; and the random value identification device receives the user identifier, the attribute name, and the attribute value from the information storing provider device, stores the user identifier and permission information indicating the attribute of which the user identified by the user identifier permits a disclosure so that they are associated in permission information storage means, reads the permission information associated with the user identifier from the permission information storage means based on the received user identifier, and identifies at least one attribute from the read permission information, stores the user identifier, the attribute name, and a random value so that they are associated in random value storage means, identifies the correlation between the attribute indicated by the attribute name received from the information storing provider device and the at least one identified attribute, generates the random number for each attribute in a random value range identified based on at least one attribute value among the received attribute values and the identified correlation, and transmits the generated random number to the information storing provider device.

A first random value identification program according to one configuration of the present invention causing a computer to execute: a process of receiving a user identifier and an attribute name of an attribute of information related to the user; a process of identifying a correlation between the attributes indicated by the attribute name; a process of acquiring at least one attribute value of the attribute of the user identified by the user identifier; and a process of generating a random number for each the attribute in a random value range identified based on the acquired attribute value and the identified correlation.

### Effect of the Invention

An example of the effect of the present invention is to be able to identify an appropriate random value by which a value of original data can be concealed and a validity of data after adding the random value can be increased.

### BRIEF DESCRIPTION OF THE DRAWINGS

FIG. 1 is a block diagram showing a configuration of a random value identification device according to a first exemplary embodiment.

FIG. 2 is a figure showing a hardware configuration of a random value identification device according to the first exemplary embodiment and peripheral devices.

FIG. 3 is a flowchart showing an outline of operation of the random value identification device according to the first exemplary embodiment.

FIG. 4 is a block diagram showing a configuration of a random value identification system according to a second exemplary embodiment.

FIG. 5 shows one example of information stored by a correlation storage unit.

FIG. 6 is a figure showing one example of information stored by an attribute value storage unit.

FIG. 7 is a figure showing an example of a predetermined subspace identified by a random value range identification unit.

FIG. 8 is a figure showing an example of a predetermined subspace identified by a random value range identification unit.

FIG. 9 is a figure showing an example of a predetermined subspace identified by a random value range identification unit.

FIG. 10 is a figure showing an example in which the subspace shown in FIG. 7 is rotated.

FIG. 11 is a figure showing certain attribute information, a range in which a value after adding a random number to each attribute value included in the attribute information can be taken, and a function indicating a correlation between an attribute “age” and an attribute “annual income”.

FIG. 12 is a flowchart showing an outline of operation of the random value identification system according to the second exemplary embodiment.

FIG. 13 is a flowchart showing an outline of operation of a random value range identification unit according to the second exemplary embodiment.

FIG. 14 is a block diagram showing a configuration of a random value identification system according to a first modification example of the second exemplary embodiment.

FIG. 15 is a block diagram showing a configuration of a random value identification system according to a second modification example of the second exemplary embodiment.

FIG. 16 is a block diagram showing a configuration of a random value identification system according to a third exemplary embodiment.

FIG. 17 is a figure showing an example of information stored by a permission information storage unit.

FIG. 18 is a figure showing an example of information stored by an attribute value storage unit.

FIG. 19 is a flowchart showing an outline of operation of a random value identification system according to the third exemplary embodiment.

FIG. 20 is a block diagram showing a configuration of a random value identification system according to a first modification example of the third exemplary embodiment.

FIG. 21 is a block diagram showing a configuration of a random value identification system according to a fourth exemplary embodiment.

FIG. 22 is a block diagram showing a configuration of an information storing provider device according to the fourth exemplary embodiment.

FIG. 23 is a block diagram showing a configuration of a random value identification device according to the fourth exemplary embodiment.

FIG. 24 is a flowchart showing an outline of operation of a random value identification system according to the fourth exemplary embodiment.

FIG. 25 is a figure showing a specific example of a correlation between “age” and “annual income” and a range in which a value after adding a random value to original data can be taken.

### EXEMPLARY EMBODIMENT OF THE INVENTION

An exemplary embodiment for carrying out the present invention will be described in detail with reference to the drawing. Further, in each drawing and each exemplary embodiment described in the specification, the same reference number is used for the elements having a similar function. And, the detailed explanation of the element to which the same reference number is assigned may be omitted.

### First Exemplary Embodiment

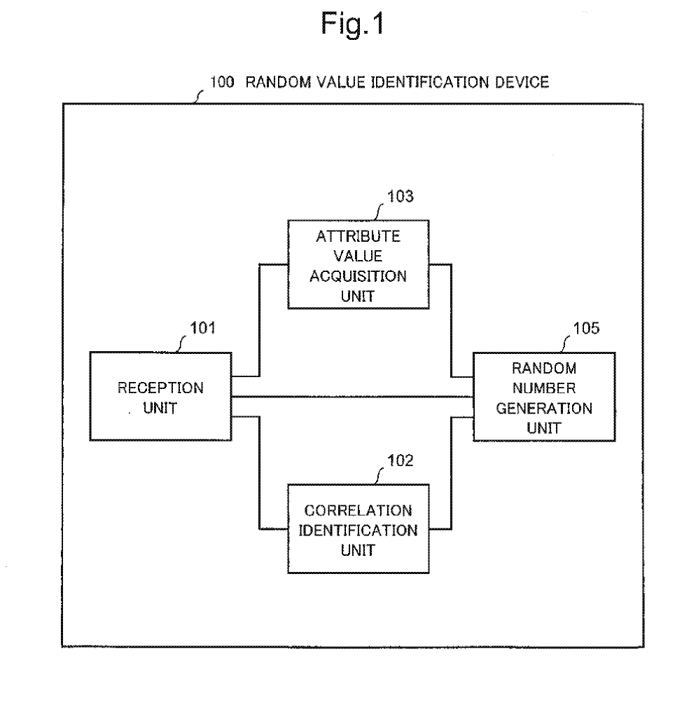

FIG. 1 is a block diagram showing a configuration of a random value identification device 100 according to a first exemplary embodiment of the present invention. Referring to FIG. 1, the random value identification device 100 includes a reception unit 101, a correlation identification unit 102, an attribute value acquisition unit 103, and a random number generation unit 105.

===Reception Unit 101===

The reception unit 101 receives a user identifier and an attribute name indicating an attribute of information related to the user from other function means or an external device which are not shown in the figure.

The user identifier is a symbol for identifying a user name or a user.

For example, the information related to the user includes all information such as personal information such as a user's age or annual income, a rent or an age of a user's house, a distance from a station to the user's house, academic ability of a user's child, information about a user's preference (information about smoking, drinking, and exercise experience), and the like.

The attribute of the information related to the user is information indicating a certain specific item about the user and a value of the item. The attribute name of the attribute of the information related to the user is information indicating a certain specific item related to the user. The attribute value of the attribute of the information related to the user is a value to a certain specific item related to the user.

In other words, the attribute of the information related to the user is, for example, information of “age=10 years old” in the information of “Alice is 10 years old”. Then, in the above-mentioned example, the attribute name of the information related to the user is “age”. Similarly, the attribute value of the attribute of the information related to the user is “10 years old”. And, in the above-mentioned example, “Alice” is the user identifier.

===Correlation Identification Unit 102===

The correlation identification unit 102 identifies the correlation between the attributes indicated by the attribute name received by the reception unit 101.

The correlation is, for example, a function between the attribute values corresponding to the attributes. However, this correlation does not have to be one to one relationship. For example, the correlation may be a multiple-value function.

The correlation identification unit 102 may receive the correlation from the correlation storage unit which is not shown in the figure. Or, the correlation identification unit 102 may receive the attribute name and the corresponded attribute value, calculate a regression curve or a regression line between the attributes based on the attribute name and the attribute value which are received, and identify the information showing the regression curve or the regression line as the correlation.

When the correlation identification unit 102 calculates the regression curve or the regression line between the attributes, the correlation identification unit 102 may calculate it by using the attribute of which the attribute value indicates a predetermined value. For example, the attribute indicating this predetermined value may be an attribute indicating a value included in a search range. The search range is information for designating a range of an attribute value of a certain attribute.

A correlation calculation unit which is not shown in the figure may calculate the correlation instead of the correlation identification unit 102 calculating the correlation.

===Attribute Value Acquisition Unit 103===

The attribute value acquisition unit 103 acquires attribute information including at least one attribute value corresponding to the attribute name received by the reception unit 101 among the information related to the user identified by the user identifier received by the reception unit 101. The attribute information is information including the attribute values of a plurality of attributes of one user. For example, data of (35 years old and 11 million yen) is the attribute information as the attribute values of the attribute “age” and the attribute “annual income”.

For example, the attribute value acquisition unit 103 may acquire the attribute information including at least one attribute value among the attribute values associated with the user identifier received by the reception unit 101 from the attribute value storage unit, which is not shown in the figure and stores the user identifier, the attribute name, and the attribute value so that they are associated. This attribute value storage unit may be included in the random value identification device 100 or be included in an external device which is not shown in the figure. And, the attribute value stored by this attribute value storage unit is the attribute value related to the user identified by the associated user identifier associated, and the attribute value of the attribute indicated by the associated attribute name.

===Random Number Generation Unit 105===

The random number generation unit 105 generates a random number for each attribute in a random value range identified based on the attribute information acquired by the attribute value acquisition unit 103 and the correlation between the attributes identified by the correlation identification unit 102. The random value range is a range in which the random number can be taken between the attributes identified by the correlation identification unit 102. The random value range is identified by using a random value range identification unit which is not shown in the figure. The random value identification device 100 may include this random value range identification unit, or another external device which is not shown in the figure may include it.

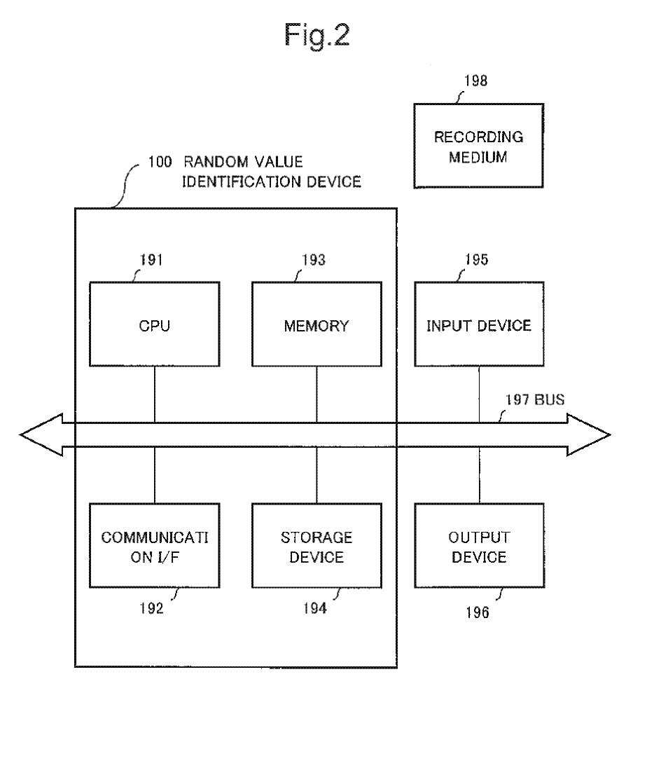

FIG. 2 is a figure showing an example of a hardware configuration of the random value identification device 100 according to the first exemplary embodiment of the present invention and peripheral devices. As shown in FIG. 2, the random value identification device 100 includes a CPU (Central Processing Unit) 191, a communication I/F (Interface) 192 for network connection (communication interface 192), a memory 193, and a storage device 194 such as a hard disk or the like which stores a program. And, the random value identification device 100 is connected to an input device 195 and an output device 196 via a bus 197.

The CPU 191 operates an operating system and controls the entire random value identification device 100 according to the first exemplary embodiment of the present invention. And, the CPU 191, for example, reads a program and data from a recording medium 198 mounted on the drive device or the like to the memory 193, and executes each kinds of processes as the reception unit 101, the correlation identification unit 102, the attribute value acquisition unit 103, and the random number generation unit 105 according to the first exemplary embodiment based on the program and the data.

The storage device 194 is, for example, an optical disk, a flexible disk, a magnetic optical disk, an external hard disk, a semiconductor memory, or the like, and stores a computer program as computer-readable. Or, the computer program may be downloaded from an external computer which is not shown in the figure and connected to a communication network.

The input device 195, for example, is realized by a mouse, a keyboard, a built-in key/button, or the like, and used for input operation. For example, the input device 195 may be not only the mouse, the keyboard, and the built-in key button but also a touch panel, an accelerometer, a gyro sensor, a camera, or the like.

The output device 196, for example, is realized by a display, and used for checking the output.

Further, the block diagram (FIG. 1) used for explaining the first exemplary embodiment is not show a configuration of hardware units but blocks of functional units. These functional blocks are realized based on a hardware configuration shown in FIG. 2. However, realizing means of each unit included in the random value identification device 100 are not limited to the description described in FIG. 1 and FIG. 2. Namely, the random value identification device 100 may be realized by one device that is physically combined or may be realized by two or more devices that are physically separated and connected by a wired line or a wireless line.

And, the CPU 191 may read the computer program recorded in the storage device 194, and execute as the reception unit 101, the correlation identification unit 102, the attribute value acquisition unit 103, and the random number generation unit 105 according to the program.

And, the recording medium (or the storage medium) storing a code of the above-mentioned program is supplied to the random value identification device 100, and the random value identification device 100 may read the code of the program stored in the recording medium and execute the program. Namely, the present invention also includes the recording medium 198 which transitory or non-transitory stores software (information processing program) executed by the random value identification device 100 according to the first exemplary embodiment.

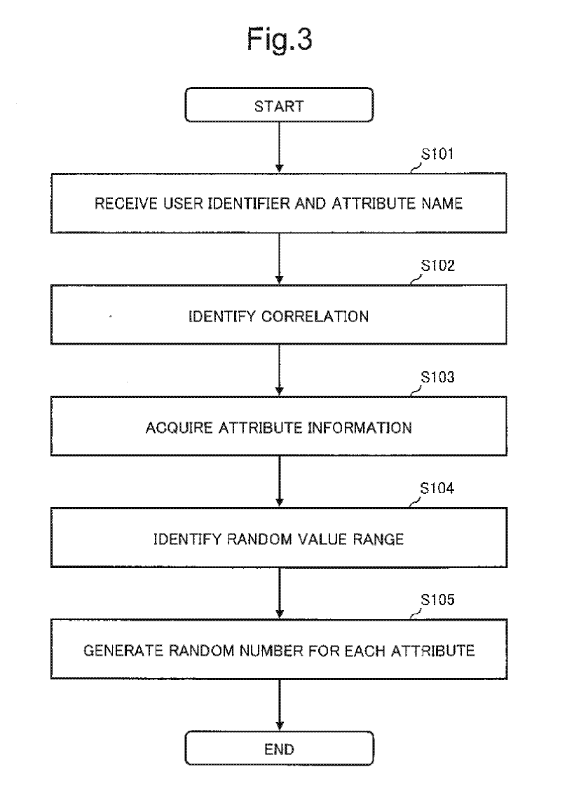

FIG. 3 is a flowchart showing an outline of operation of the random value identification device 100 according to the first exemplary embodiment.

The reception unit 101 receives the user identifier and the attribute name related to the corresponding user (step S101). The correlation identification unit 102 identifies the correlation between the attributes indicated by the attribute name received by the reception unit 101 (step S102). The attribute value acquisition unit 103 acquires the attribute information including at least one attribute value corresponding to the attribute name received by the reception unit 101 among the information related to the user identified by the user identifier received by the reception unit 101 (step S103).

The random number generation unit 105 generates the random number for each attribute in the random value range identified based on the attribute information acquired by the attribute value acquisition unit 103 and the correlation between the attributes identified by the correlation identification unit 102 (step S104).

The random value identification device 100 according to the first exemplary embodiment receives the attribute name of the attribute of the information related to the user, and identifies the correlation between the attributes indicated by the received attribute name. And, the random value identification device 100 acquires the attribute information including at least one attribute value corresponding to the attribute name of the user. Then, the random value identification device 100 generates the random number which is added to the attribute value, based on the random value range identified based on both information of the acquired attribute information and the above-mentioned identified correlation.

The random value range is a range in which the random number can be taken between the attributes. Because the random value range is based on the value of the attribute value to which the random number is added, it takes a different value for each attribute value. And, because the random value range is based on the correlation between the attributes, the random number included in the random value range is a value based on the correlation between the attributes. Accordingly, even when the random number is added to the attribute value, a possibility that the value of the attribute value to which the random value is added is a value that the data can take becomes high. Further, confidentiality of the original data is maintained.

Accordingly, the random value identification device 100 according to the first exemplary embodiment can identify an appropriate random value which can conceal the value of the original data and can increase a validity of the data after adding the random value.

For example, in the technology described in non-patent document 1, the random value is calculated based on a correlation value between the attributes. Here, in the technology described in non-patent document 1, a random noise value is calculated by using a single calculation method that is not related to the value of the original data. Therefore, the technology described in non-patent document 1 can be applied to only a case in which the correlation value clearly exists between the attributes of the original data, in other words, a case in which the correlation between the attributes of the original data is represented by a first-order line. And, in the technology described in patent document 1 and patent document 1, a range in which the random value added to the original data can be taken is not identified according to the original data. Therefore, the value of the data to which the random value is added is greatly different from the value of the original data, and the validity of the data is reduced.

On the other hand, the random value identification device 100 according to the first exemplary embodiment generates the random number added to the original data based on the random value range identified on the basis of the value of the original data. Therefore, the random value identification device 100 can be applied to even a case in which the correlation between the attributes is, for example, a curve line other than the first-order line. Moreover, in the first exemplary embodiment, even when the random value included in the random value range is added to the original data, the value of the data to which the random value is added is relatively close to the value of the original data. Yet further, confidentiality of the original data is maintained. This advantage is obtained because a size corresponding to the size of the predetermined subspace that is identified based on range information stored by the random value identification device 100 is secured as the size of the random value range.

### Second Exemplary Embodiment

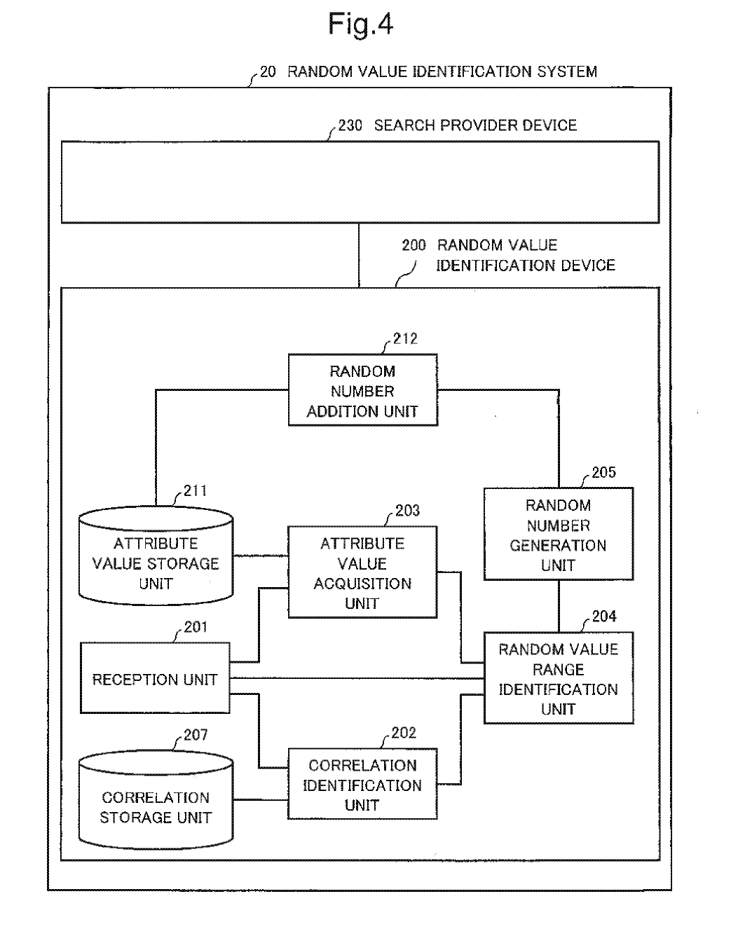

FIG. 4 is a block diagram showing a configuration of a random value identification system 20 according to a second exemplary embodiment of the present invention. Referring to FIG. 4, the random value identification system 20 includes a search provider device 230 and a random value identification device 200.

<Search Provider Device 230>

The search provider device 230 transmits the user identifier and the attribute name of the attribute of the information related to the user to the random value identification device 200 described later. The search provider device 230 may receive the user identifier from an external device which is not shown in the figure, or may include a user information storage unit which is not shown in the figure for storing the user identifier and read the user identifier stored in the user information storage unit.

The search provider device 230 may transmit the search range that is information indicating a range of the attribute value corresponding to the above-mentioned attribute name to the random value identification device 200.

When the search provider device 230 receives the attribute value to which the random value is added, it outputs the received attribute value.

<Random Value Identification Device 200>

The random value identification device 200 includes a reception unit 201, a correlation identification unit 202, an attribute value acquisition unit 203, a random value range identification unit 204, a random number generation unit 205, a correlation storage unit 207, an attribute value storage unit 211, and a random number addition unit 212.

===Correlation Storage Unit 207===

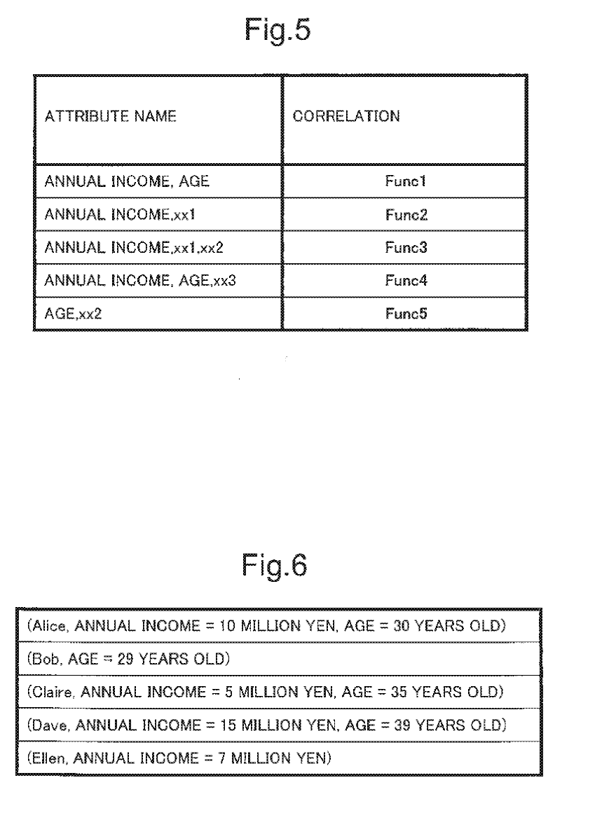

The correlation storage unit 207 stores the correlation between the attributes. FIG. 5 shows one example of information stored by the correlation storage unit 207. Referring to FIG. 5, for example, the correlation storage unit 207 stores “annual income” and “age” which are the attribute names of the attribute, and “Fund” which is a substance of a function indicating the correlation between the attributes as the correlation so that they are associated.

===Attribute Value Storage Unit 211===

The attribute value storage unit 211 stores the user identifier, the attribute name, and the attribute value so that they are associated. This attribute value is an attribute value of the attribute related to the user identified by the user identifier associated with the attribute value. And, this attribute name is an attribute name of the above-mentioned attribute. FIG. 6 is a figure showing one example of information stored by the attribute value storage unit 211. Referring to FIG. 6, the attribute value storage unit 211, for example, stores the user identifier “Alice”, the attribute name “annual income” and its attribute value “10 million yen”, and the attribute name “age” and its attribute value “30 years old” so that they are associated.

===Reception Unit 201===

The reception unit 201 has a function which is similar to the function which the reception unit 101 has. For example, the reception unit 201 receives the user identifier and the attribute name from the search provider device 230, and sends the user identifier and the attribute name that are received to the correlation identification unit 202. And, when the reception unit 201 receives the search range from the search provider device 230, it sends the received search range to the correlation identification unit 202.

The search range is information for designating a range of the attribute value of a certain attribute.

===Correlation Identification Unit 202===

The correlation identification unit 202 has a function which is similar to the function which the correlation identification unit 102 has. And, the correlation identification unit 202 receives the search range from the reception unit 201. When the correlation identification unit 202 receives the attribute name and the corresponding attribute value, it identifies the attribute value indicating the value included in the search range. For example, the correlation identification unit 202 calculates the regression curve or the regression line between the attributes based on the identified attribute value and the corresponding attribute name. The correlation identification unit 202 identifies the information indicating the calculated regression line or regression line as a correlation, and stores the correlation in the correlation storage unit 207. A correlation calculation unit which is not shown in the figure may calculate the correlation instead of the correlation identification unit 202 calculating the correlation.

===Attribute Value Acquisition Unit 203===

The attribute value acquisition unit 203 has a function which is similar to the function which the attribute value acquisition unit 103 has. For example, the attribute value acquisition unit 203 acquires the attribute information including at least one attribute value corresponding to the attribute name received by the reception unit 201 from the attribute value storage unit 211 based on the user identifier received by the reception unit 201. This attribute information is information identified from the information related to the user identified by the user identifier received by the reception unit 201. Specifically, the attribute value acquisition unit 203 reads the attribute value associated with the user identifier received by the reception unit 201 from the attribute value storage unit 211. Then, the attribute value acquisition unit 203 identifies the attribute value corresponding to the attribute name received by the reception unit 201 among the read attribute values, and identifies the attribute information including at least one identified attribute value.

===Random Value Range Identification Unit 204===

The random value range identification unit 204 identifies the random value range based on the attribute information acquired by the attribute value acquisition unit 203 and the correlation between the attributes identified by the correlation identification unit 202. The random value range is a range in which the random number can be taken between the attributes identified by the correlation identification unit 202.

The random value range identification unit 204 may store the range information indicating a predetermined range or a range of the attribute value for each attribute. Then, the random value range identification unit 204 may identify the random value range based on the range information corresponding to the attribute indicated by the attribute name received by the reception unit 201, the attribute information acquired by the attribute value acquisition unit 203, and the correlation identified by the correlation identification unit 202.

Specifically, the random value range identification unit 204 may identify the random value range based on the following process. First, the random value range identification unit 204 calculates a tangent vector to a predetermined function corresponding to the correlation identified by the correlation identification unit 102 based on each attribute value included in the attribute information acquired by the attribute value acquisition unit 203.

For example, it is assumed that the predetermined function corresponding to the correlation is a two-dimensional (“age” and “annual income”) function. It is assumed that one point indicated by the attribute information on this two-dimensional space is indicated as (x0, y0). The random value range identification unit 204 calculates the tangent line (tangent vector) at a certain point (p, q) on the function whose normal vector passes through the point (x0, y0).

Or, the random value range identification unit 204 may calculate the tangent line (tangent vector) at a certain point (x0, q) or a certain point (p, y0) on the function. For example, when the number of dimensions of the space in which the predetermined function corresponding to the correlation is defined is greater than the number of the attribute values included in the attribute information acquired by the attribute value acquisition unit 203, the random value range identification unit 204 calculates the tangent vector at a certain point on the function including the attribute value.

In the above-mentioned example, a calculation method for the two-dimensional space is shown as an example, but the predetermined function corresponding to the correlation may be three or more dimensions. Even in the above-mentioned case, the random value range identification unit 204 calculates the tangent vector by using a method which is similar to the above-mentioned method.

The functions corresponding to the correlation is even two or more acceptable. When the functions corresponding to the correlation are plurality, the random value range identification unit 204 selects the function whose distance from the attribute information acquired by the attribute value acquisition unit 203 is the smallest, and calculates the tangent vector to the function based on the above-mentioned attribute information.

Secondly, the random value range identification unit 204 identifies the predetermined subspace which is a part of the space whose axes are the attributes based on the range information corresponding to the attribute indicated by the attribute name received by the reception unit 201.

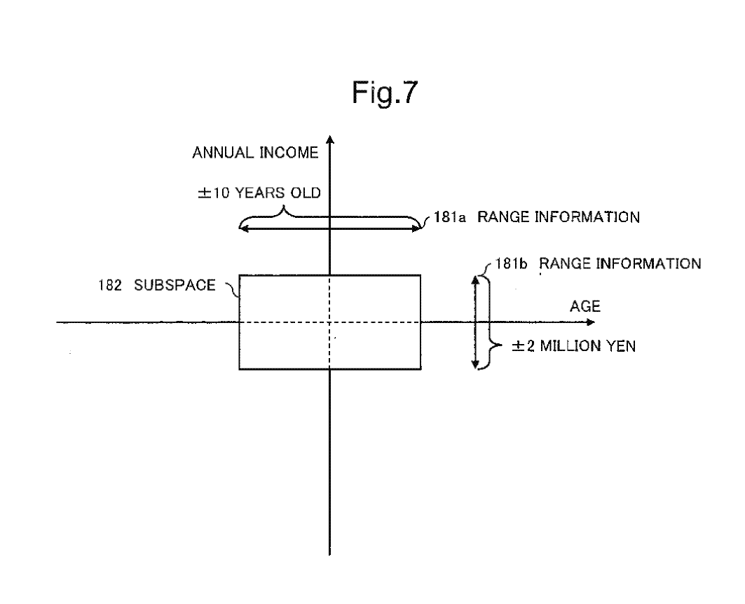

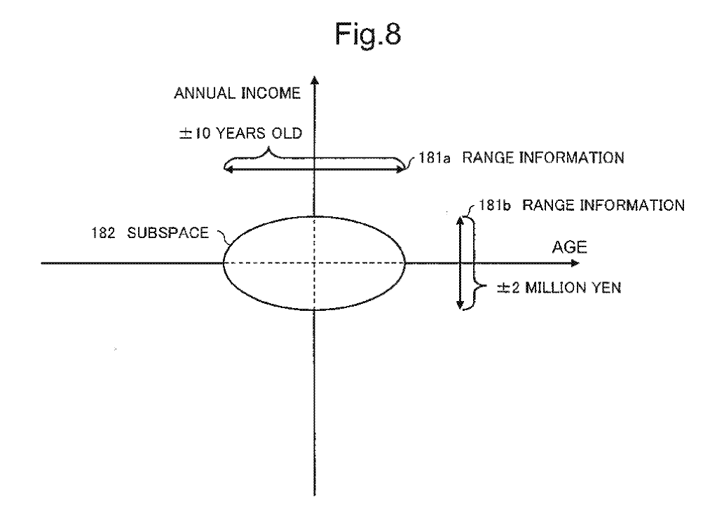

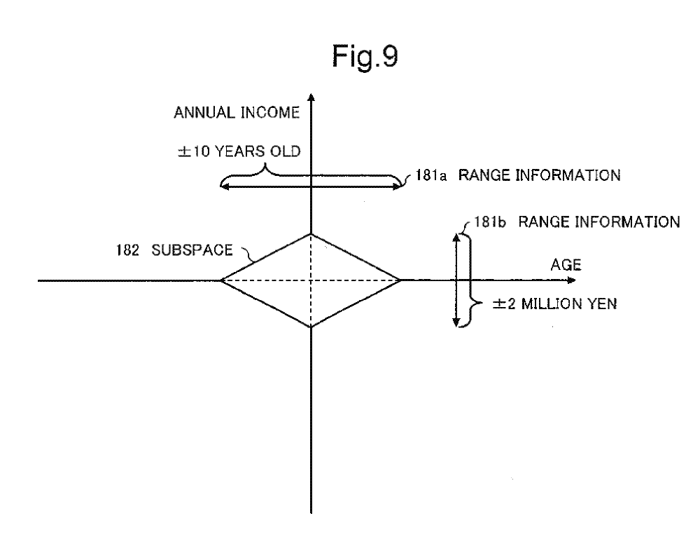

FIG. 7, FIG. 8, and FIG. 9 are figures showing an example of a predetermined subspace identified by the random value range identification unit 204. These figures are shown as an example, and the predetermined subspace is not limited to the shape shown as the example. Referring to FIG. 7, FIG. 8, and FIG. 9, the random value range identification unit 204 stores a range information 181a about the attribute name “age” and a range information 181b about the attribute name “annual income” as the range information. The value of the range information 181a is “plus minus 10 years old”. The value of the range information 181b is “plus minus 2 million”. Then, the random value range identification unit 204 identifies a predetermined subspace 182 based on these range information 181a and 181b.

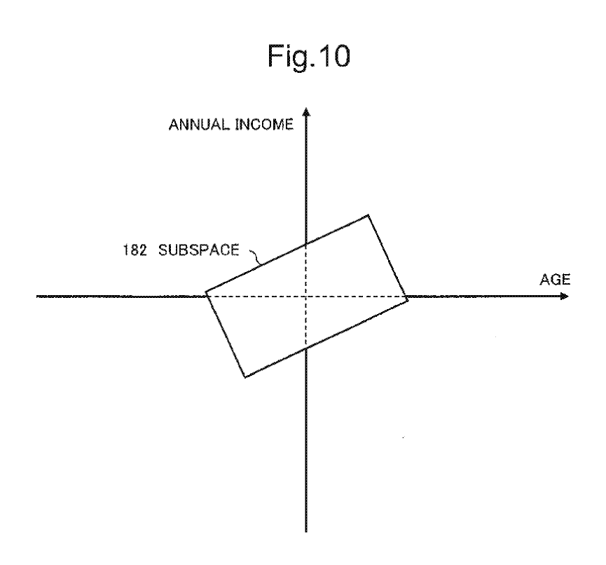

Thirdly, the random value range identification unit 204 rotates the identified subspace based on the calculated tangent vector. FIG. 10 is a figure showing an example in which the subspace 182 shown in FIG. 7 is rotated.

For ease of explanation, for example, it is assumed that the tangent vector calculated by the random value range identification unit 204 is the tangent vector at a certain point (p, q). The random value range identification unit 204 may calculate an inclination (differential value) f′ of this tangent vector. In this case, the random value range identification unit 204 rotates the identified subspace by an angle θ based on the calculated differential value f′. This angle θ corresponds to an inclination angle of the tangent vector (tangent line) corresponding to the differential value f′. For example, the angle θ is a value calculated by the following [Equation 1]. In [Equation 1], α is a predetermined constant number.

$$tan θ = \frac{{f}^{′}}{α} \qquad [ Equation 1 ]$$

The predetermined constant number α may be stored in the random value range identification unit 204 in advance or it may be information received from an external device which is not shown in the figure.

When the number of the attributes is three or more, the above-mentioned angle θ or differential value f′ is an angle or a function on a plane which consists of two attributes. The random value range identification unit 204 selects two attributes among three or more attributes, and calculates the angle θ or the differential value f′.

When the coordinate of the random value included in the predetermined subspace 182 shown in FIG. 7 is expressed by the value indicated by [Equation 2], the coordinate of the random value when the random value is mapped in the space rotated by the angle θ can be calculated by using [Equation 3].

$$\begin{matrix}( \begin{matrix}X \\ Y\end{matrix} ) & [ Equation 2 ] \\ ( \begin{matrix}{X}^{′} \\ {Y}^{′}\end{matrix} ) = ( \begin{matrix}cos θ & - sin θ \\ sin θ & cos θ\end{matrix} ) ( \begin{matrix}X \\ Y\end{matrix} ) & [ Equation 3 ]\end{matrix}$$

The random value range identification unit 204 identifies the subspace evaluated by using the above-mentioned process as the random value range.

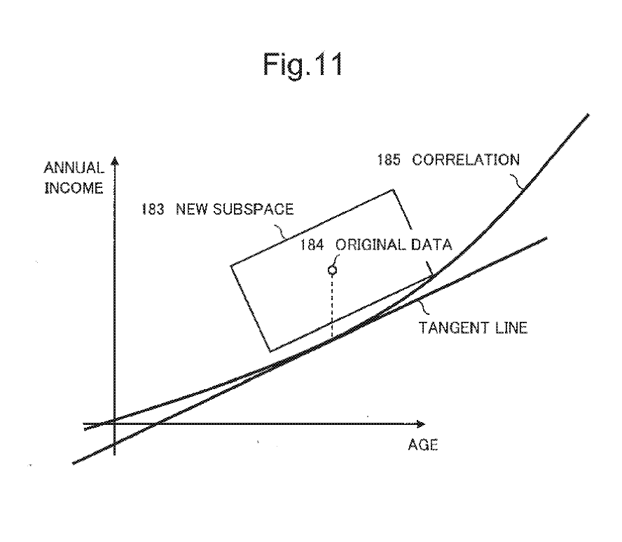

FIG. 11 is a figure showing certain attribute information, a range in which a value after adding the random number to each attribute value included in the attribute information can be taken, and a function (correlation 185) indicating the correlation between the attribute “age” and the attribute “annual income”. Referring to FIG. 11, original data 184 which is data of the original attribute information is converted into one of values in a new subspace 183 by adding the random value. The size of the range of the value in which the data after conversion can be taken is the same as the size of the subspace 182 shown in FIG. 7. A possibility that the original data is deciphered from the converted data depends on the size of the subspace 182. When the size of this new subspace 183 is sufficiently large, the security of the original data is guaranteed. The size of this new subspace 183 depends on the range information stored by the random value range identification unit 204.

The random value range identification unit 204 may update the value of the stored range information based on a distance between the attribute information acquired by the attribute value acquisition unit 203 and the function corresponding to the correlation corresponding to the correlation identified by the correlation identification unit 202. For example, the random value range identification unit 204 may update the value of the range information by multiplying the size of the range of the range information by a coefficient proportional to the distance between a certain point indicated by the attribute information and the function.

The distance between the attribute information acquired by the attribute value acquisition unit 203 and the function corresponding to the correlation corresponding to the correlation identified by the correlation identification unit 202 may be a length of the normal vector used when the random value range identification unit 204 calculates the tangent vector. In an example of the attribute information of the above-mentioned two dimensional space, it is assumed that one point indicated by the attribute information in this two dimension space is indicated as (x0, y0). The random value range identification unit 204 calculates the length of the normal vector at a certain point (p, q) on the function whose normal vector passes through the point (x0, y0). Then, the random value range identification unit 204 identifies the calculated length of the normal vector as the above-mentioned distance.

Because the attribute information whose distance from the function corresponding to the correlation is large is a value showing that it has a peculiar value, a possibility that the user corresponding to the attribute information is identified becomes high. Accordingly, the user's privacy can be protected by updating (for example, enlarging) the value of the range information according to the distance from the function corresponding to the correlation. And, because the attribute information whose distance from the function corresponding to the correlation is not large is the value showing that it has a general value that is not peculiar, a possibility that the user corresponding to the attribute information is identified becomes low. Accordingly, the user's privacy can be protected and the validity of data can be increased by updating (for example, reducing) the value of the range information according to the distance from the function corresponding to the correlation.

The random value range identification unit 204 may generate the range information based on the information received from an external device which is not shown in the figure or other functional means, and store the generated range information. For example, when the reception unit 201 receives the attribute name and the range information indicating the range of the attribute value corresponding to the attribute name with the attribute name, the random value range identification unit 204 stores the value of the range information as the range information of the attribute indicated by the attribute name.

===Random Number Generation Unit 205===

The random number generation unit 205 has a function which is similar to the function which the random number generation unit 105 has. For example, the random number generation unit 205 generates the random number for each corresponding attribute so that the random value is included in the random value range identified by the random value range identification unit 204.

===Random Number Addition Unit 212===

The random number addition unit 212 receives the random value corresponding to each attribute which is generated by the random number generation unit 205. The random number addition unit 212 reads the attribute value corresponding to the attribute name received by the reception unit 201 among the attribute values associated with the user identifier received by the reception unit 201 from the attribute value storage unit 211. Then, the random number addition unit 212 adds the random value corresponding to the attribute indicated by the attribute name to each read attribute value. The random number addition unit 212 transmits each attribute value to which the random value is added to the search provider device 230.

The random value identification device 200 according to the second exemplary embodiment may receive the predetermined constant number α and the range information that are used by the random value range identification unit 204 from the search provider device 230. The user using the search provider device 230 can customize the random value range by setting these values (constant number α and range information) to the random value identification device 200. As a result, the user of the search provider device 230 of the random number identification system of the present invention can increase the validity of the data after adding the random value and identify the appropriate random value.

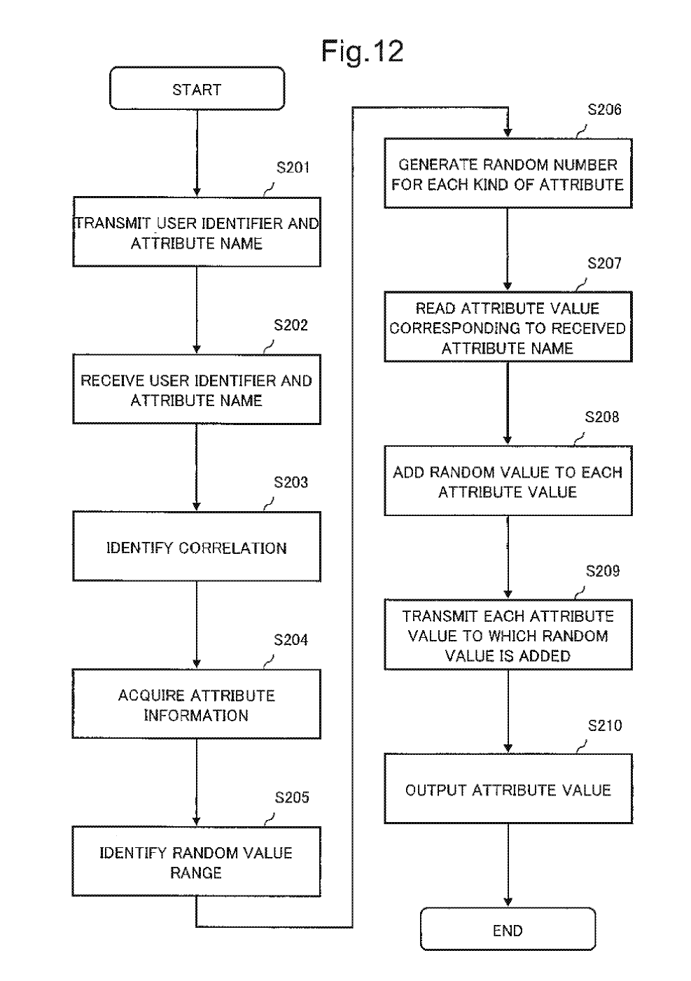

FIG. 12 is a flowchart showing an outline of operation of the random value identification system 20 according to the second exemplary embodiment.

The search provider device 230 transmits the user identifier and the attribute name related to the corresponding user to the random value identification device 200 (step S201). The user identifier and the attribute name may be determined based on the information received from an external device which is not shown in the figure.

The reception unit 201 receives the user identifier and the attribute name (step S202). The correlation identification unit 202 identifies the correlation between the attributes indicated by the attribute name received by the reception unit 201 (step S203). The attribute value acquisition unit 203 acquires the attribute information including at least one attribute value corresponding to the attribute name received by the reception unit 201 from the attribute value storage unit 211 based on the user identifier received by the reception unit 201 (step S204). This attribute information is identified among the information related to the user identified by the user identifier received by the reception unit 201.

The random value range identification unit 204 identifies the random value range which is a range in which the random number can be taken between the attributes based on the attribute information acquired by the attribute value acquisition unit 203 and the correlation between the attributes identified by the correlation identification unit 202 (step S205). The random number generation unit 205 generates the random number for each corresponding attribute so that the random value is included in the random value range identified by the random value range identification unit 204 (step S206).

The random number addition unit 212 receives the random value corresponding to each attribute generated by the random number generation unit 205. The random number addition unit 212 reads the attribute value corresponding to the attribute name received by the reception unit 201 among the attribute values associated with the user identifier received by the reception unit 201 from the attribute value storage unit 211 (step S207). Then, the random number addition unit 212 adds the random value corresponding to the attribute indicated by the corresponding attribute name to each read attribute value (step S208). The random number addition unit 212 transmits each attribute value to which the random value is added to the search provider device 230 (step S209). When the search provider device 230 receives the attribute value to which the random value is added from the random value identification device 200, the search provider device 230 outputs the received attribute value (step S210).

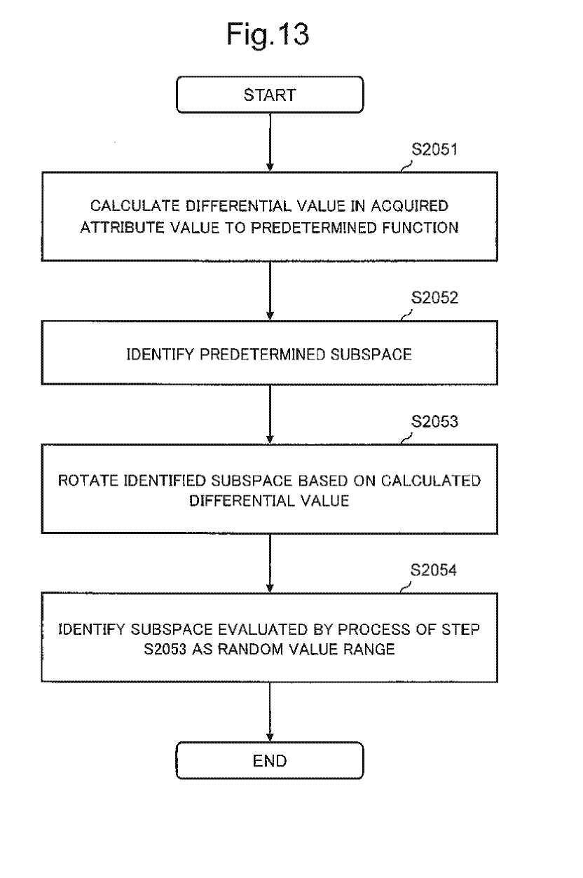

FIG. 13 is a flowchart showing an outline of operation of the random value range identification unit 204 according to the second exemplary embodiment.

The random value range identification unit 204 calculates the tangent vector (differential value) based on the attribute information acquired by the attribute value acquisition unit 203 to the predetermined function included in the correlation identified by the correlation identification unit 202 (step S2051).

The random value range identification unit 204 identifies the predetermined subspace which is a part of the space whose axis is the attribute based on the range information corresponding to the attribute indicated by the attribute name received by the reception unit 201 (step S2052).

The random value range identification unit 204 rotates the identified subspace based on the calculated tangent vector (differential value) (step S2053).

The random value range identification unit 204 identifies the subspace evaluated by the process of step S2053 as the random value range (step S2054).

The random value identification system 20 according to the second exemplary embodiment includes the element provided in the random value identification device 100 according to the first exemplary embodiment. Accordingly, the random value identification system 20 according to the second exemplary embodiment has a similar effect similar of the random value identification device 100 according to the first exemplary embodiment.

And, the random value identification system 20 according to the second exemplary embodiment identifies the attribute value for calculating the correlation based on a search range which is information for designating a range of a certain attribute value. For example, when the user identifies the search range, the random value range which is the range of the value of the random value added to the attribute value is identified by using the correlation calculated based on the attribute value having the value included in the search range. In other words, the random value range is identified according to the value of the attribute value included in the search range designated by the user. For example, even when locally, there is a correlation between the attribute values included in the search range and there is no large correlation between all the attribute values, the random value identification system 20 according to the second exemplary embodiment can identify the random value range in which the correlation is appropriately reflected.

Therefore, the random value identification system 20 according to the second exemplary embodiment can identify the random value with which the validity of the data after adding the random value can be increased.

The random value identification system 20 according to the second exemplary embodiment identifies the attribute value indicating the value included in the received search range, and calculates the regression curve or the regression line between the attributes based on the identified attribute value and the corresponding attribute name. In other words, even when the attribute value frequently changes, the random value identification system 20 identifies the random value range which identifies the random value added to the attribute value based on the attribute value at the time of reception of the search range. Therefore, the random value identification system 20 according to the second exemplary embodiment can identify the random value range in which the correlation is appropriately reflected according to the changed attribute value even when the attribute value frequently changes. Namely, the random value identification system 20 according to the second exemplary embodiment can identify the random value which can increase the validity of the data after adding the random value.

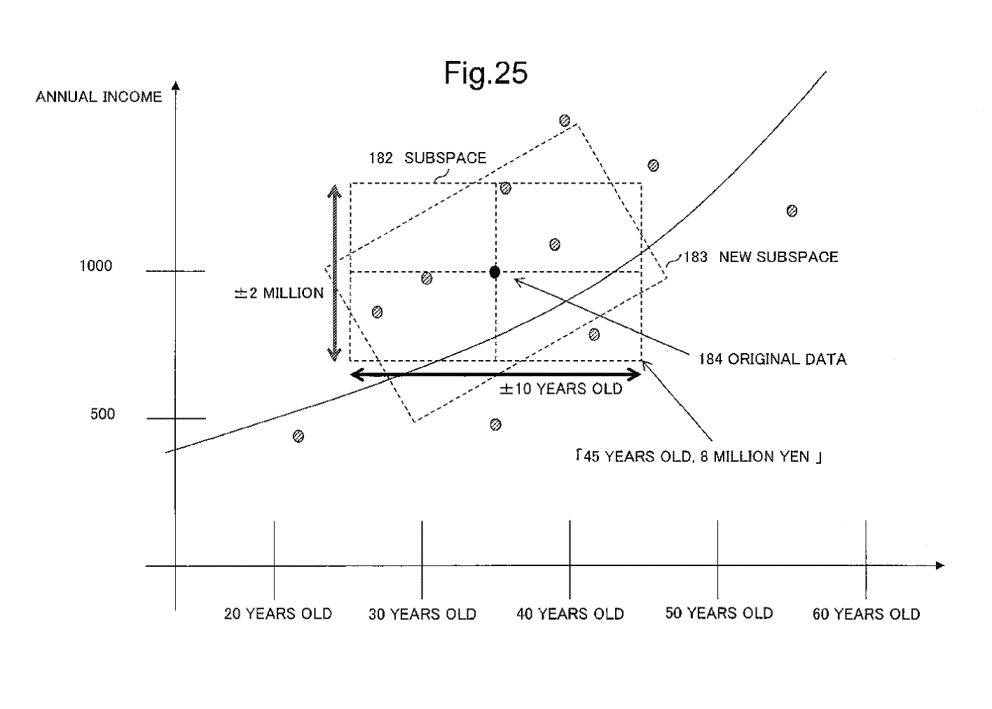

For example, it is assumed that the user of the random value identification system 20 according to the second exemplary embodiment searches for a person of “age between 25 and 45, and annual income between 8 million yen and 12 million yen”. This user enters the attribute name “age” and “annual income”, the attribute value “35 years old” and “10 million yen”, and the search range “plus minus 10 years” of “age”, and the search range “plus minus 2 million yen” of “annual income” to the random value identification system 20. The random value identification device 200 identifies the correlation between the attribute name “age” and “annual income”. For example, FIG. 25 is a figure showing the correlation between “age” and “annual income”. The random value identification system 20 identifies the attribute value (original data 184) included in the search range “25 to 45 years old” and “8 to 12 million yen”. Then, the random value identification system 20 identifies the random value range based on the attribute value. Then, the random value identification system 20 identifies a certain random value in the random value range, and adds it to the attribute value. The value to which the random value is added is a value included in the new subspace 183.

The system according to the related technology adds the random number to the attribute value by applying the range information corresponding to the attribute to each attribute. Therefore, for example, in a case in which the range information is “plus minus 10 years old, and plus minus 2 million yen”, in the related technology, the original data “35 years old and 10 million yen” is converted into the data “45 years old and 8 million yen”. These values are the maximum value in which the value of “age” can be taken and the minimum value in which the value of “annual income” can be taken. These values after conversion are values greatly different from the correlation between “age” and “annual income”. On the other hand, the random value identification system 20 according to the second exemplary embodiment can identify the value which the original data 184 can not take with the subspace 182 but with the new subspace 183. Therefore, in the random value identification system 20 according to the second exemplary embodiment, the original data “35 years old and 10 million yen” is not converted into the data “45 years old and 8 million yen” like the above-mentioned example.

### First Modification Example of the Second Exemplary Embodiment

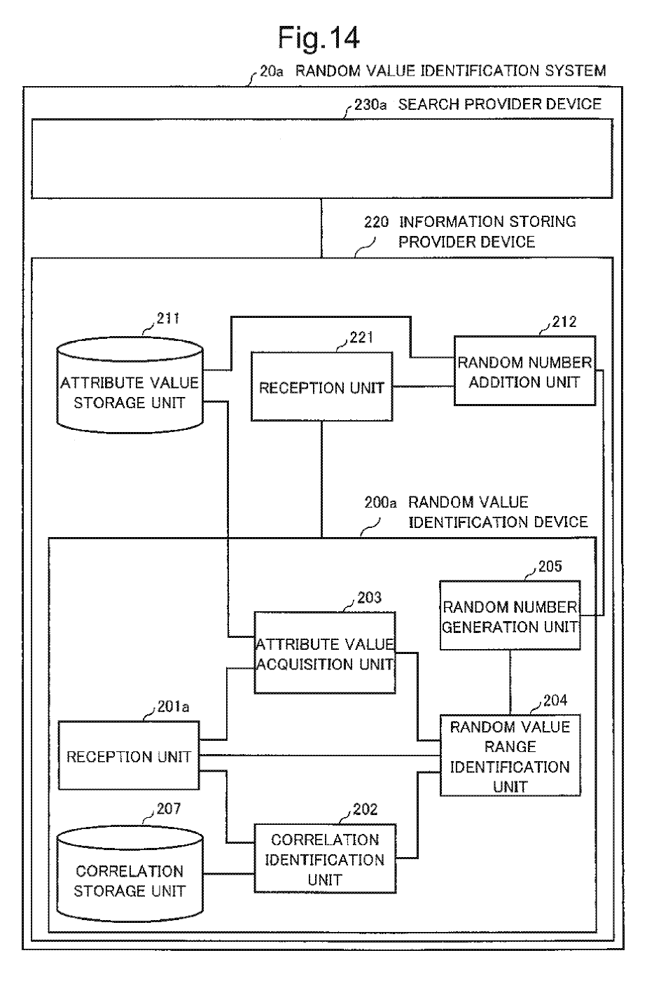

FIG. 14 is a block diagram showing a configuration of a random value identification system 20a according to a first modification example of the second exemplary embodiment of the present invention. Referring to FIG. 14, the random value identification system 20a includes a search provider device 230a and an information storing provider device 220.

<Search Provider Device 230a>

The search provider device 230a transmits the user identifier and the attribute name of the attribute of the information related to the user to the information storing provider device 220 described later. The search provider device 230a may receive the user identifier from an external device which is not shown in the figure, or may include a user information storage unit which is not shown in the figure and stores the user identifier and read the user identifier stored in the user information storage unit.

The search provider device 230a may transmit the search range which is information indicating a range of the attribute value corresponding to the above-mentioned attribute name to the information storing provider device 220.

When the search provider device 230a receives the attribute value to which the random value is added, it outputs the received attribute value.

<Information Storing Provider Device 220>

The information storing provider device 220 includes a random value identification device 200a, a reception unit 221, the attribute value storage unit 211, and the random number addition unit 212.

===Reception Unit 221===

The reception unit 221 receives the user identifier and the attribute name from the search provider device 230a, and sends the user identifier and the attribute name which are received to the random value identification device 200a. And, when the reception unit 221 receives the search range from the search provider device 230a, it sends the received search range to the random value identification device 200a.

<Random Value Identification Device 200a>

The random value identification device 200a includes a reception unit 201a, the correlation identification unit 202, the attribute value acquisition unit 203, the random value range identification unit 204, the random number generation unit 205, and the correlation storage unit 207.

===Reception Unit 201a===

The reception unit 201a receives the user identifier and the attribute name from the reception unit 221, and sends the user identifier and the attribute name which are received to the correlation identification unit 202. And, when the reception unit 201a receives the search range from the reception unit 221, it sends the received search range to the correlation identification unit 202.

The random value identification system 20a according to the first modification example of the second exemplary embodiment includes similar elements of the random value identification system 20 according to the second exemplary embodiment. Accordingly, the random value identification system 20a according to the first modification example of the second exemplary embodiment has a similar effect of the random value identification system 20 according to the second exemplary embodiment.

### Second Modification Example of the Second Exemplary Embodiment

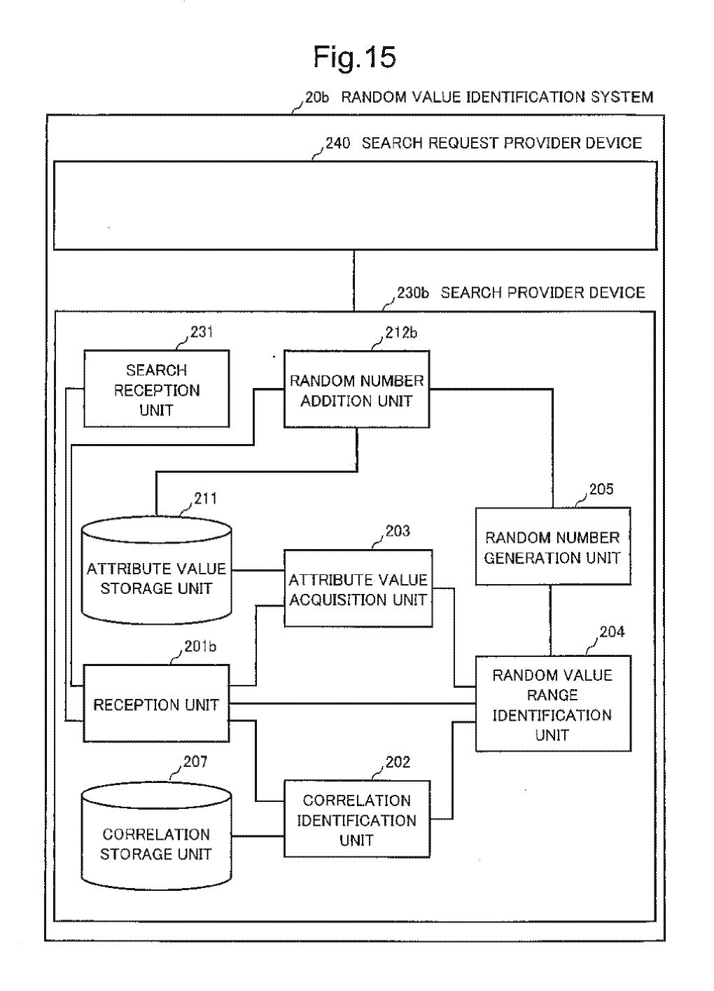

FIG. 15 is a block diagram showing a configuration of a random value identification system 20b according to a second modification example of the second exemplary embodiment of the present invention. Referring to FIG. 15, the random value identification system 20b includes a search request provider device 240 and a search provider device 230b.

<Search Request Provider Device 240>

The search request provider device 240 transmits the search range indicating a range of a certain attribute value to the search provider device 230b. The search request provider device 240 may transmit the user identifier to the search provider device 230b.

When the search request provider device 240 receives the attribute value to which the random value is added, it outputs the received attribute value for each user corresponding to each attribute value.

<Search Provider Device 230b>

The search provider device 230b includes a search reception unit 231, a reception unit 201b, the correlation identification unit 202, the attribute value acquisition unit 203, the random value range identification unit 204, the random number generation unit 205, the correlation storage unit 207, the attribute value storage unit 211, and a random number addition unit 212b.

===Search Reception Unit 231===

The search reception unit 231 receives the search range indicating a range of a certain attribute value from the search request provider device 240. Then, the search reception unit 231 sends the received search range, the user identifier, and the attribute name of the attribute of information related to the user to the reception unit 201b described later. This attribute name is an attribute name of the attribute corresponding to the attribute value indicated by the received search range.

The search reception unit 231 may receive the user identifier from the search request provider device 240. And, the search reception unit 231 may include a user information storage unit which is not shown in the figure and stores the user identifier, and read the user identifier stored in the user information storage unit. The search reception unit 231 may send all the user identifiers received from the search request provider device 240 to the reception unit 201b. Or, the search reception unit 231 may send all the user identifiers stored in the user information storage unit which is not shown in the figure to the reception unit 201b.

When the search reception unit 231 receives the attribute value to which the random value is added from the random number addition unit 212b, it performs the following process for each user corresponding to each attribute value. First, the search reception unit 231 identifies the attribute corresponding to the range of the attribute value indicated by the search range received from the search request provider device 240. Then, the search reception unit 231 transmits the attribute value to which the random value is added of the user whose all attribute values corresponding to the identified attribute are acquired to the search request provider device 240.

The process in which the search reception unit 231 sends the user identifier to the reception unit 201b may be performed whenever the search range is received from the search request provider device 240 or may be performed independently of the process of receiving the search range from the search request provider device 240.

===Reception Unit 201b===

The reception unit 201b receives the user identifier and the attribute name from the search reception unit 231, and sends the user identifier and the attribute name to the correlation identification unit 202. And, when the reception unit 201b receives the search range from the search reception unit 231, it sends the received search range to the correlation identification unit 202.

===Random Number Addition Unit 212b===

The random number addition unit 212b receives the random value corresponding to each attribute generated by the random number generation unit 205. The random number addition unit 212 reads the attribute value corresponding to the attribute name received by the reception unit 201b among the attribute values associated with the user identifier received by the reception unit 201b from the attribute value storage unit 211. Then, the random number addition unit 212b adds the random value corresponding to the attribute indicated by the attribute name to each read attribute value. The random number addition unit 212b sends each attribute value to which the random value is added to the search reception unit 231.

The random value identification system 20b according to the second modification example of the second exemplary embodiment includes similar elements of the random value identification system 20 according to the second exemplary embodiment. Accordingly, the random value identification system 20b according to the second modification example of the second exemplary embodiment has a similar effect of the random value identification system 20 according to the second exemplary embodiment.

### Third Exemplary Embodiment

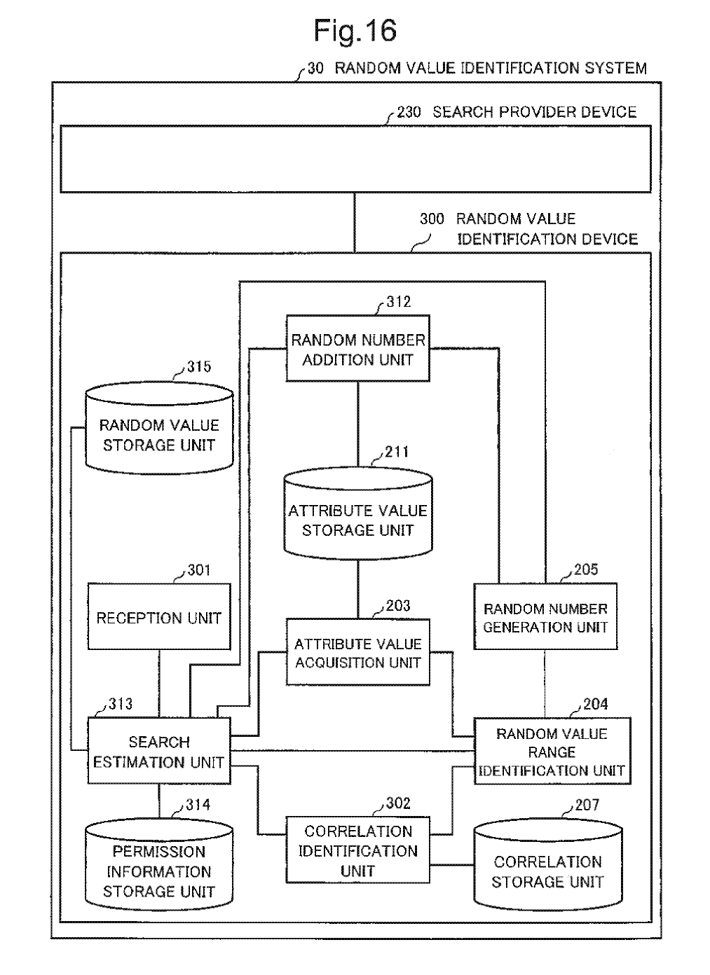

FIG. 16 is a block diagram showing a configuration of a random value identification system 30 according to a third exemplary embodiment of the present invention. Referring to FIG. 16, the random value identification system 30 includes the search provider device 230 and a random value identification device 300.

<Random Value Identification Device 300>

The random value identification device 300 includes a reception unit 301, a correlation identification unit 302, the attribute value acquisition unit 203, the random value range identification unit 204, the random number generation unit 205, the correlation storage unit 207, the attribute value storage unit 211, a random number addition unit 312, a search estimation unit 313, a permission information storage unit 314, and a random value storage unit 315.

===Reception Unit 301===

The reception unit 301 receives the user identifier and the attribute name from the search provider device 230, and sends the user identifier and the attribute name which are received to the search estimation unit 313. And, when the reception unit 301 receives the search range from the search provider device 230, it sends the received search range to the search estimation unit 313.

===Permission Information Storage Unit 314===

The permission information storage unit 314 stores the permission information indicating at least one attribute of which the user permits a disclosure and the user identifier for identifying the user so that they are associated.

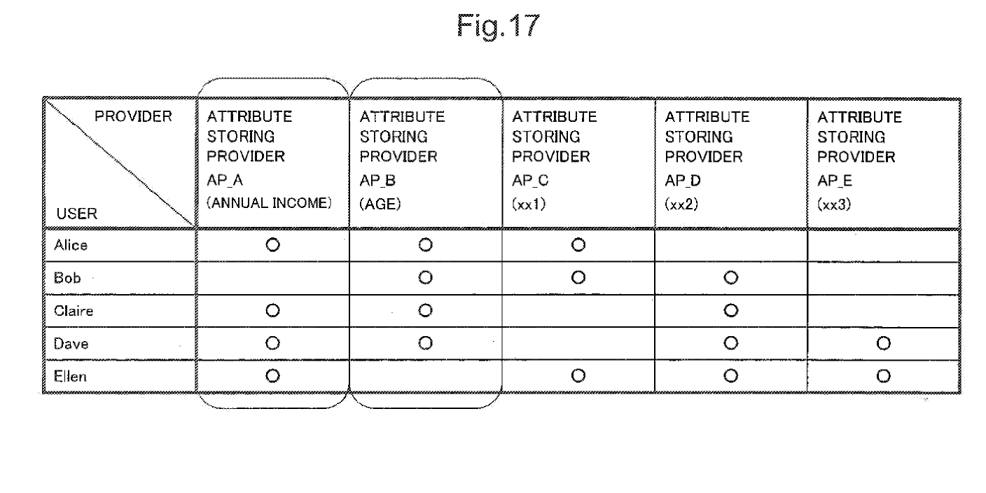

FIG. 17 is a figure showing an example of information stored by the permission information storage unit 314. Referring to FIG. 17, the permission information storage unit 314 stores the user identifier “Alice” and the permission information so that they are associated. The permission information of the user “Alice” shows the permission of the disclosure of the attribute name “annual income”, “age”, and “xx1”. Similarly, the permission information storage unit 314 stores the user identifier “Bob”, “Claire”, “Dave”, “Ellen”, and the permission information of each user so that they are associated. In an example shown in FIG. 17, a condition in which an information storing provider AP_A stores information related to the attribute name “annual income” is assumed. Similar conditions are assumed to other information storing providers.

The permission information storage unit 314 may store provider permission information showing the provider of which the user permits the disclosure, the user identifier, and the permission information so that they are associated. An example of information processing using the provider permission information is described later.

The random value identification system 30 may have the permission information storage unit 314 for each provider. In this case, each search provider device 230 transmits a provider identifier showing the provider together with the user identifier and the attribute name to the random value identification device 300. Then, the random value identification device 300 performs a process based on the information stored in the permission information storage unit 314 corresponding to the received provider identifier.

===Random Value Storage Unit 315===

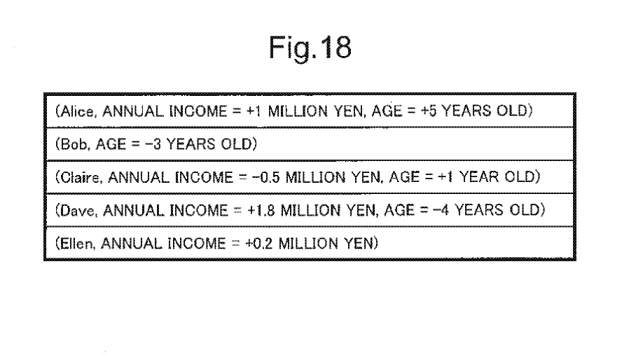

The random value storage unit 315 stores the user identifier, the attribute name, and the random value added to the attribute value corresponding to the attribute name so that they are associated. FIG. 18 is a figure showing an example of information stored by the random value storage unit 315. Referring to FIG. 18, for example, the random value storage unit 315 stores the user identifier “Alice”, the attribute name “annual income” and its random value “+1 million yen”, and, the attribute name “age” and its random value “+5 years old” so that they are associated.

The random value storage unit 315 may further store the search range associated with the above-mentioned information.

===Search Estimation Unit 313===

When the search estimation unit 313 receives the user identifier and the attribute name from the reception unit 301, it judges whether or not the user identifier and the attribute name are stored in the random value storage unit 315 so that they are associated. Then, when the search estimation unit 313 judges that the user identifier and the attribute name are store in the random value storage unit 315 so that they are associated, it performs the following process. Namely, the search estimation unit 313 reads the random value that is associated with the user identifier and the attribute name from the random value storage unit 315. Then, the search estimation unit 313 sends the attribute name and the random value to the random number addition unit 312 described later.

When the search estimation unit 313 receives the user identifier, the attribute name, and the search range from the reception unit 301, it judges whether or not the user identifier, the attribute name, and the search range are stored in the random value storage unit 315 so that they are associated. The process performed by the search estimation unit 313 when it judges that the user identifier and the attribute name are stored in the random value storage unit 315 so that they are associated is similar to the above-mentioned process.

When the search estimation unit 313 judges that the user identifier and the attribute name are stored in the random value storage unit 315 so that they are associated, a part or all of the process of the elements described later as an example may be omitted. The elements are, for example, the correlation identification unit 302, the attribute value acquisition unit 203, the random value range identification unit 204, and the random number generation unit 205.

When the search estimation unit 313 judges that the user identifier and the attribute name are not stored in the random value storage unit 315 so that they are associated, it performs the following process. Namely, the search estimation unit 313 judges whether or not the permission information associated with the user identifier is stored in the permission information storage unit 314, based on the user identifier received by the reception unit 301. Then, the search estimation unit 313 judges that the permission information is stored, it reads the permission information from the permission information storage unit 314. Then, the search estimation unit 313 identifies at least one attribute in the read permission information. For example, the search estimation unit 313 may identify at least one attribute other than the attribute corresponding to the attribute name received from the reception unit 301.

The search estimation unit 313 sends the user identifier received from the reception unit 301, the attribute name, and the attribute name indicating the above-mentioned identified attribute to the correlation identification unit 302.

And, when the search estimation unit 313 receives the random value identified by the random value identification unit 106, it stores the random value, the attribute name of the attribute corresponding to the attribute value to which the random value is added, and the user identifier received from the reception unit 301 in the random value storage unit 315 so that they are associated.

When the reception unit 301 receives the search range, the search estimation unit 313 stores the above-mentioned random value, the attribute name, the user identifier, and the search range so that they are associated.

When the permission information storage unit 314 stores the provider permission information, the search provider device 230 sends the provider identifier showing the predetermined provider to the random value identification device 300.

Then, when the provider shown by the received provider identifier is included in the provider shown by the provider permission information associated with the permission information read from the permission information storage unit 314, the search estimation unit 313 may perform the following process. Namely, the search estimation unit 313 may send the user identifier and the attribute information to the correlation identification unit 302.

On the other hand, when the provider shown by the received provider identifier is not included in the provider shown by the provider permission information associated with the permission information read from the permission information storage unit 314, the search estimation unit 313 performs the following process. Namely, the search estimation unit 313 transmits information indicating that the search fails to the search provider device 230.

===Correlation Identification Unit 302===

The correlation identification unit 302 has a similar function of the correlation identification unit 202 according to the second exemplary embodiment except for the point of receiving the user identifier, the attribute name, and the search range from the search estimation unit 313.

===Random Number Addition Unit 312===

The random number addition unit 312 receives the random value corresponding to each attribute generated by the random number generation unit 205 or the random value read from the random value storage unit 315 by the search estimation unit 313. The random number addition unit 312 reads the attribute value corresponding to the attribute name received from the reception unit 301 by the search estimation unit 313 among the attribute values associated with the user identifier received from the reception unit 301 by the search estimation unit 313 from the attribute value storage unit 211. Then, the random number addition unit 312 adds the random value corresponding to the attribute indicated by the attribute name to each read attribute value. The random number addition unit 312 outputs each attribute value to which the random value is added.

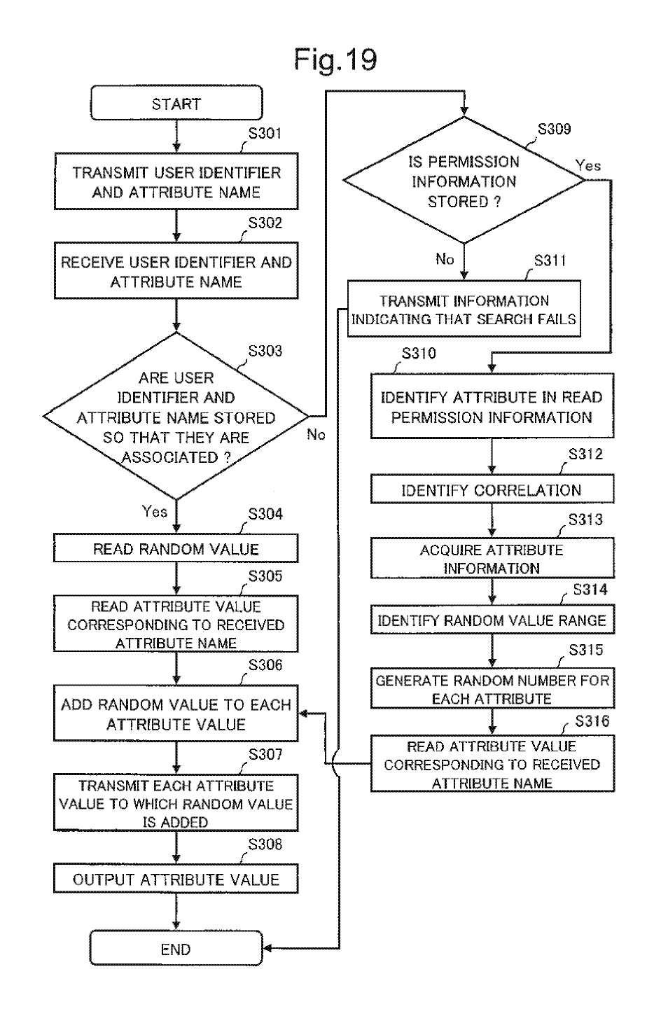

FIG. 19 is a flowchart showing an outline of operation of the random value identification system 30 according to the third exemplary embodiment.

The search provider device 230 transmits the user identifier and the attribute name to the random value identification device 300 (step S301). The user identifier and the attribute name may be determined based on the information received from an external device which is not shown in figure.

The reception unit 301 receives the user identifier and the attribute name related to the corresponding user (step S302). The search estimation unit 313 judges whether or not the user identifier and the attribute name which are received by the reception unit 301 are stored in the random value storage unit 315 so that they are associated (step S303).

When the search estimation unit 313 judges that the user identifier and the attribute name are stored in the random value storage unit 315 so that they are associated (“Yes” in step S303), it performs the following process. Namely, the search estimation unit 313 reads the random value associated with the user identifier and the attribute name from the random value storage unit 315, and sends it to the random number addition unit 312 (step S304).

The random number addition unit 312 receives the random value which is read from the random value storage unit 315 by the search estimation unit 313. The random number addition unit 312 reads the attribute value corresponding to the attribute name received by the reception unit 301 among the attribute values associated with the user identifier received by the reception unit 301 from the attribute value storage unit 211 (step S305).

Then, the random number addition unit 312 adds the random value corresponding to the attribute indicated by the attribute name to each read attribute value (step S306). The random number addition unit 312 transmits each attribute value to which the random value is added (step S307). When the search provider device 230 receives the attribute value to which the random value is added from the random value identification device 300, it outputs the received attribute value (step S308). Then, the process of the random value identification system 30 ends.

On the other hand, when the search estimation unit 313 judges that the user identifier and the attribute name are not stored in the random value storage unit 315 so that they are associated (“No” in step S303), it performs the following process. Namely, the search estimation unit 313 judges whether or not the permission information associated with the user identifier is stored in the permission information storage unit 314 based on the user identifier received by the reception unit 301 (step S309).

When the search estimation unit 313 judges that the permission information is stored (“Yes” in step S309), it reads the permission information from the permission information storage unit 314. Then, the search estimation unit 313 identifies at least one attribute in the read permission information (step S310). Then, the process of the random value identification system 30 proceeds to step S312. On the other hand, when the search estimation unit 313 judges that the permission information is not stored (“No” in step S309), it transmits information indicating that the search fails to the search provider device 230 (step S311). Then, the process of the random value identification system 30 ends.

When the search estimation unit 313 identifies at least one attribute in the permission information read in step S310, it sends the user identifier, the attribute name, and the search range to the correlation identification unit 302. The correlation identification unit 302 identifies the correlation between the attributes indicated by the attribute name received by the reception unit 301 (step S312). The attribute value acquisition unit 203 acquires the attribute information including at least one attribute value corresponding to the attribute indicated by the attribute name received by the reception unit 301 from the attribute value storage unit 211 based on the user identifier received by the reception unit 301 (step S313). This attribute information is information identified among the information related to the user identified by the user identifier received by the reception unit 301.

The random value range identification unit 204 identifies the random value range which is a range in which the random number can be taken between the attributes, based on the attribute information acquired by the attribute value acquisition unit 203 and the correlation between the attributes identified by the correlation identification unit 302 (step S314). The random number generation unit 205 generates the random number for each corresponding attribute so that the random value is included in the random value range identified by the random value range identification unit 204 (step S315).

The random number addition unit 312 receives the random value corresponding to each attribute generated by the random number generation unit 205. The random number addition unit 312 reads the attribute value corresponding to the attribute name received by the reception unit 301 among the attribute values associated with the user identifier received by the reception unit 301 from the attribute value storage unit 211 (step S316). Then, the process of the random value identification system 30 proceeds to step S306.

The random value identification system 30 according to the third exemplary embodiment includes the elements provided in the random value identification device 100 according to the first exemplary embodiment. Accordingly, the random value identification system 30 according to the third exemplary embodiment has a similar effect of the random value identification device 100 according to the first exemplary embodiment.

And, the random value identification system 30 according to the third exemplary embodiment identifies another attribute permitted by the user, based on the permission information indicating at least one attribute of which the user permits a disclosure and the attribute name transmitted by the search provider device 230. Then, the random value identification system 30 identifies the correlation between the attribute identified by the attribute name and the above-mentioned another attribute, and identifies the random value range which is a range of the random value added to the attribute value based on the correlation.

For example, there is a case in which the search provider device 230 uses a plurality of search queries for searching one fact. For example, the case in which “age” and “annual income” of the user identifier “Alice” are searched is assumed. Here, for example, the search provider device 230 transmits the user identifier “Alice” and the attribute name “age” to the random value identification device 300. The random value identification device 300 receives the user identifier “Alice” and the attribute name “age”, and reads the permission information associated with the user identifier “Alice” to the permission information storage unit 314.

Referring to FIG. 17, the permission information of “Alice” permits the disclosure of the attribute “age”, “annual income”, and “xx1”. The random value identification device 300 identifies the attribute “annual income” that is not indicated by the received attribute name, and identifies the correlation between the attribute “age” and “annual income”. The random value identification device 300 identifies the random value range based on the identified correlation. The random value identification device 300 adds the random value included in any one of the identified random value ranges to the attribute value of “age” of “Alice”, and returns it to the search provider device 230.

Next, the search provider device 230 transmits the user identifier “Alice” and the attribute name “annual income” to the random value identification device 300. In this case, the random value identification device 300 judges that the user identifier “Alice”, the attribute name “annual income”, and the predetermined random value are stored in the random value storage unit 315, adds the random value to the attribute value of “annual income” of “Alice”, and returns it to the search provider device 230.

Therefore, even when the plurality of search queries are used for searching for one fact as mentioned above, the random value identification system 30 according to the third exemplary embodiment can surmise the query after next time based on the first search query of the first time. Further, the random value identification system 30 according to the third exemplary embodiment can identify the appropriate random value range based on the surmise result. In other words, the random value identification system 30 according to the third exemplary embodiment can identify the random value which can increase the validity of the data after adding the random value.

### First Modification Example of the Third Exemplary Embodiment

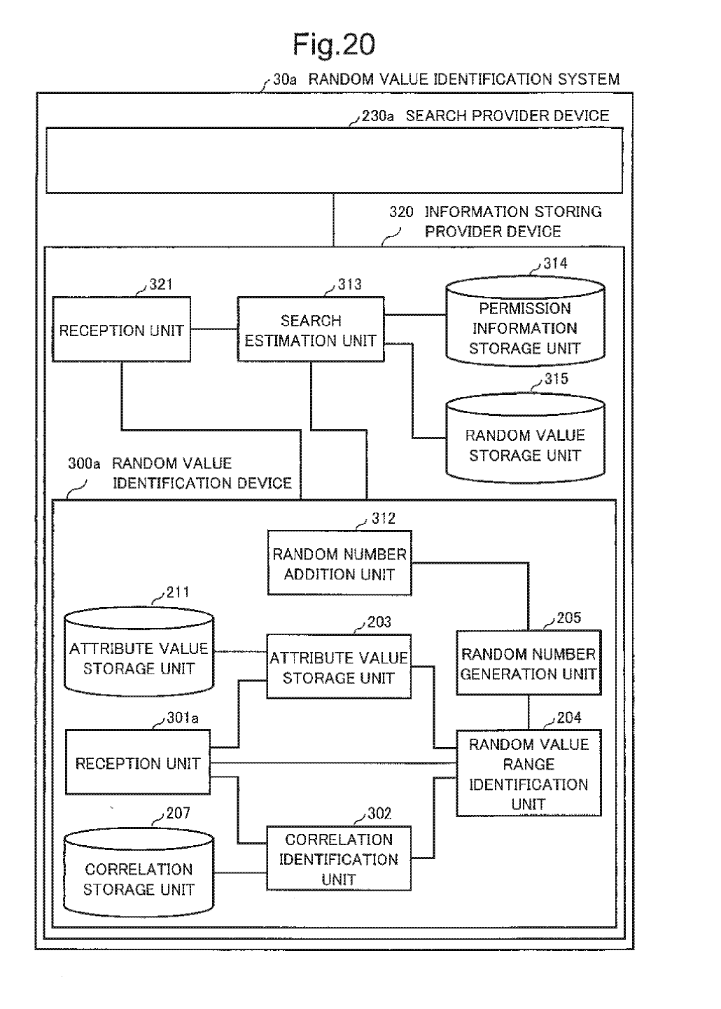

FIG. 20 is a block diagram showing a configuration of a random value identification system 30a according to a first modification example of a third exemplary embodiment of the present invention. Referring to FIG. 20, the random value identification system 30a includes the search provider device 230a and an information storing provider device 320.

<Information Storing Provider Device 320>

The information storing provider device 320 includes a reception unit 321, the search estimation unit 313, the permission information storage unit 314, the random value storage unit 315, and a random value identification device 300a.

===Reception Unit 321===

The reception unit 321 receives the user identifier and the attribute name from the search provider device 230a, and sends the user identifier and the attribute name which are received to the search estimation unit 313.

And, when the reception unit 321 receives the search range from the search provider device 230a, it sends the received search range to the random value identification device 300a.

<Random Value Identification Device 300a>

The random value identification device 300a includes a reception unit 301a, the correlation identification unit 302, the attribute value acquisition unit 203, the random value range identification unit 204, the random number generation unit 205, the correlation storage unit 207, and the random number addition unit 312.

===Reception Unit 301a===

The reception unit 301a receives the user identifier and the attribute name from the search estimation unit 313 of the information storing provider device 320, and sends the user identifier and the attribute name which are received to the correlation identification unit 202. And, when the reception unit 301a receives the search range from the reception unit 321 of the information storing provider device 320, it sends the received search range to the correlation identification unit 302.

The random value identification system 30a according to the first modification example of the third exemplary embodiment includes similar elements of the random value identification system 30 according to the third exemplary embodiment. Accordingly, the random value identification system 30a according to the first modification example of the third exemplary embodiment has a similar effect of the random value identification system 30 according to the third exemplary embodiment.

### Fourth Exemplary Embodiment

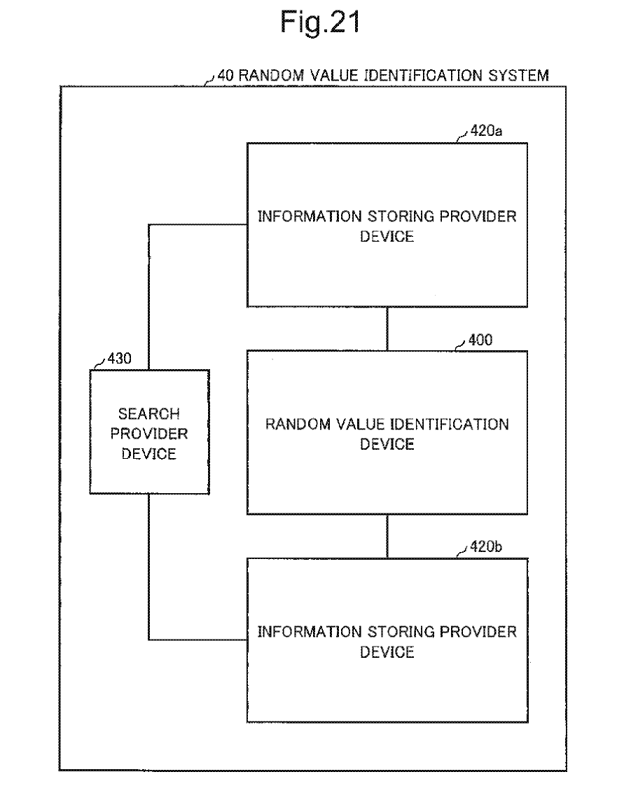

FIG. 21 is a block diagram showing a configuration of a random value identification system 40 according to a fourth exemplary embodiment of the present invention. Referring to FIG. 21, the random value identification system 40 includes a search provider device 430, an information storing provider device 420a, an information storing provider device 420b, and a random value identification device 400.

In the fourth exemplary embodiment, an information storing provider device 420 is a generic name of the information storing provider devices 420a and 420b.

<Search Provider Device 430>

The search provider device 430 transmits the user identifier and the attribute name of the attribute of the information related to the user to the information storing provider device 420a and the information storing provider device 420b described later. The search provider device 430 may receive the user identifier from an external device which is not shown in the figure, or may include a user information storage unit which is not shown in the figure and stores the user identifier and read the user identifier stored in the user information storage unit.

And, the search provider device 430 may transmit a public key generated by the search provider device 430 to the information storing provider device 420. This public key is a public key of the fully homomorphic encryption.

When the search provider device 430 receives the attribute value to which the random value is added, it outputs the received attribute value. And, when the search provider device 430 receives the attribute value which is encrypted and to which the random value is added, it decodes the received attribute value by using a secret key corresponding to the above-mentioned public key. Then, the search provider device 430 outputs the decoded attribute value.

In the fourth exemplary embodiment, the search provider device 430 may transmit the public key when it transmits the user identifier and the attribute name to the information storing provider device 420, or may transmit the public key to the information storing provider device 420 in advance.

<Information Storing Provider Device 420>

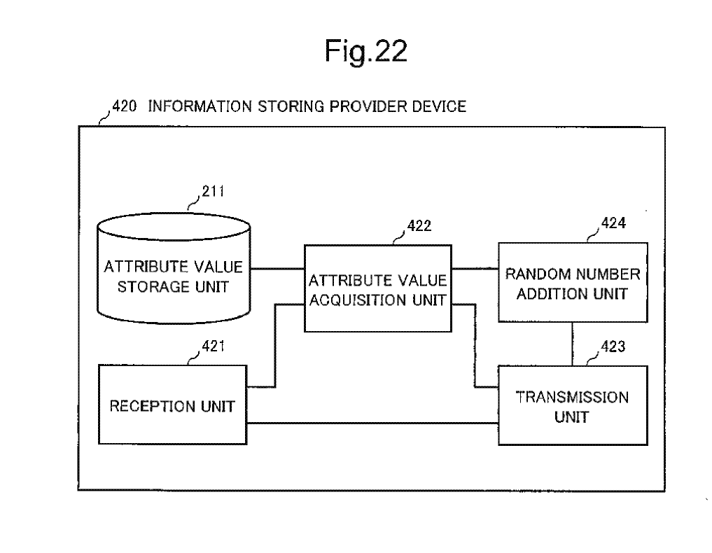

FIG. 22 is a block diagram showing an example of a configuration of the information storing provider device 420 according to the fourth exemplary embodiment of the present invention. Referring to FIG. 22, the information storing provider device 420 includes a reception unit 421, the attribute value storage unit 211, an attribute value acquisition unit 422, a transmission unit 423, and a random number addition unit 424.

===Reception Unit 421===

The reception unit 421 receives the user identifier and the attribute name from the search provider device 430. Then, the reception unit 421 sends the user identifier and the attribute name which are received to the attribute value acquisition unit 422.

When the reception unit 421 receives the public key generated by the search provider device 430 from the search provider device 430, it sends the received public key to the transmission unit 423.

===Attribute Value Acquisition Unit 422===

The attribute value acquisition unit 422 receives the user identifier and the attribute name from the reception unit 421. Then, the attribute value acquisition unit 422 reads the attribute value associated with the user identifier and the attribute name which are received from the attribute value storage unit 211.

The attribute value acquisition unit 422 sends the read attribute value, the received user identifier and the received attribute name to the transmission unit 423.

===Transmission Unit 423===

The transmission unit 423 receives the user identifier, the attribute name, and the attribute value from the attribute value acquisition unit 422, and transmits the user identifier, the attribute name, and the attribute value which are received to the random value identification device 400.

The transmission unit 423 may encrypt the attribute value with a predetermined encryption and transmit it to the random value identification device 400. For example, the transmission unit 423 encrypts the attribute value by using the public key of the fully homomorphic encryption generated by the search provider device 430. Then, the transmission unit 423 transmits the encrypted attribute value to the random value identification device 400. The random value identification device 400 can perform an addition operation and a multiplication operation to the data encrypted with the fully homomorphic encryption without a plain text or the secret key. In other words, the random value identification device 400 can perform an operation of the random value by using the encrypted attribute value with the attribute value encrypted.

===Random Number Addition Unit 424===

The random number addition unit 424 receives the random value from the random value identification device 400. The random number addition unit 424 adds the random value of the attribute corresponding to the attribute value to the attribute value acquired by the attribute value acquisition unit 422.

When the random number addition unit 424 receives information indicating that the attribute value is encrypted together with the random value, it performs the following process. Namely, the random number addition unit 424 performs the addition operation of the encrypted received random value and the encrypted received attribute value while encrypted. The process of this addition operation is performed based on an algorithm corresponding to the encryption process which is applied to the attribute value by the transmission unit 423.

The random number addition unit 424 transmits the attribute value to which the random value is added to the search provider device 430. And, when the attribute value is encrypted, the random number addition unit 424 transmits the attribute value to which the random value is added and which is encrypted to the search provider device 430.

<Random Value Identification Device 400>

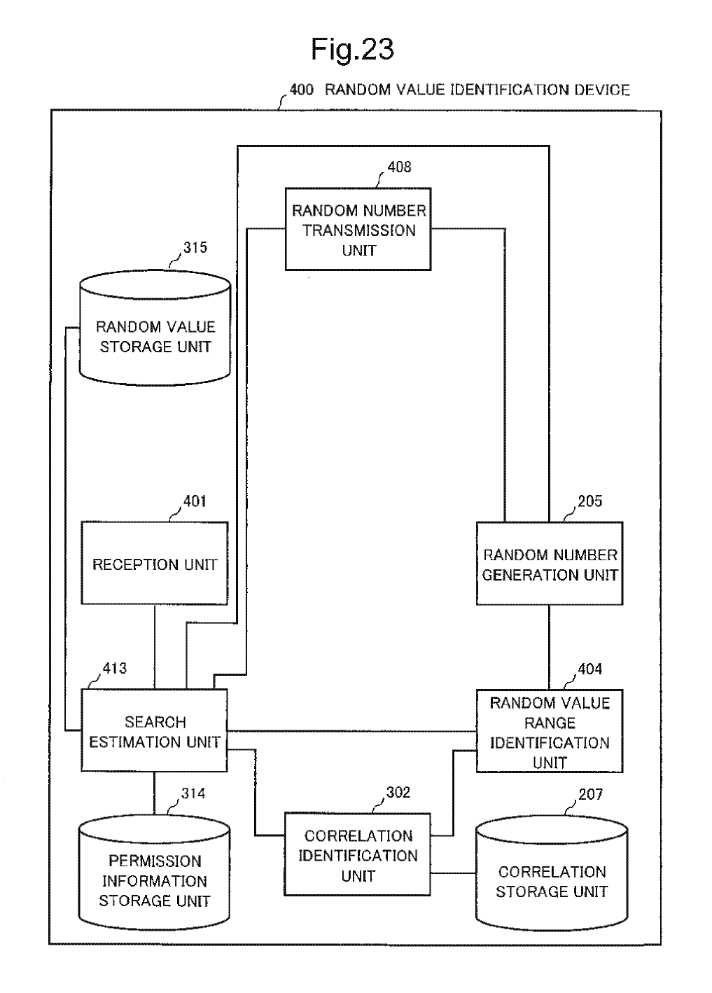

FIG. 23 is a block diagram showing an example of a configuration of the random value identification device 400 according to the fourth exemplary embodiment of the present invention. Referring to FIG. 23, the random value identification device 400 includes a reception unit 401, the correlation identification unit 302, a random value range identification unit 404, the random number generation unit 205, the correlation storage unit 207, a random number transmission unit 408, a search estimation unit 413, the permission information storage unit 314, and the random value storage unit 315.

===Reception Unit 401===

The reception unit 401 receives the user identifier, the attribute name, and the attribute value from the information storing provider device 420. Then, the reception unit 401 sends the user identifier, the attribute name, and the attribute value which are received to the search estimation unit 413.

===Random Value Range Identification Unit 404===

The random value range identification unit 404 identifies the random value range which is a range in which the random number can be taken between the attributes, based on the attribute value received from the reception unit 401 by the search estimation unit 413 and the correlation between the attributes identified by the correlation identification unit 302. And, when the attribute value is encrypted with the fully homomorphic encryption, the random value range identification unit 404 identifies the random value range by using a similar process used for the unencrypted attribute value based on the encrypted attribute value.

The specific process for identifying the random value range performed by the random value range identification unit 404 is similar to the process performed by the random value range identification unit 104 according to the first exemplary embodiment.

===Search Estimation Unit 413===

When the search estimation unit 413 receives the user identifier and the attribute name from the reception unit 401, it judges whether or not the user identifier and the attribute name are stored in the random value storage unit 315 so that they are associated. Then, when the search estimation unit 413 judges that the user identifier and the attribute name are stored in the random value storage unit 315 so that they are associated, it performs the following process. Namely, the search estimation unit 413 reads the random value associated with the user identifier and the attribute name from the random value storage unit 315. Then, the search estimation unit 413 sends the attribute name and the random value to the random number transmission unit 408 described later.

Other functions provided in the search estimation unit 413 are similar to the functions provided in the search estimation unit 313 according to the third exemplary embodiment.

===Random Number Transmission Unit 408===

The random number transmission unit 408 receives the random value generated by the random number generation unit 205 or the random value read from the random value storage unit 315 by the search estimation unit 413. The random number transmission unit 408 transmits the received random value to the information storing provider device 420. In particular, the random number transmission unit 408 transmits the random value added to the attribute corresponding to the attribute value received by the reception unit 401 to the information storing provider device 420.

When the attribute value received by the reception unit 401 is encrypted, the random number transmission unit 408 transmits the information indicating that the attribute value is encrypted to the information storing provider device 420 according to above-mentioned information.

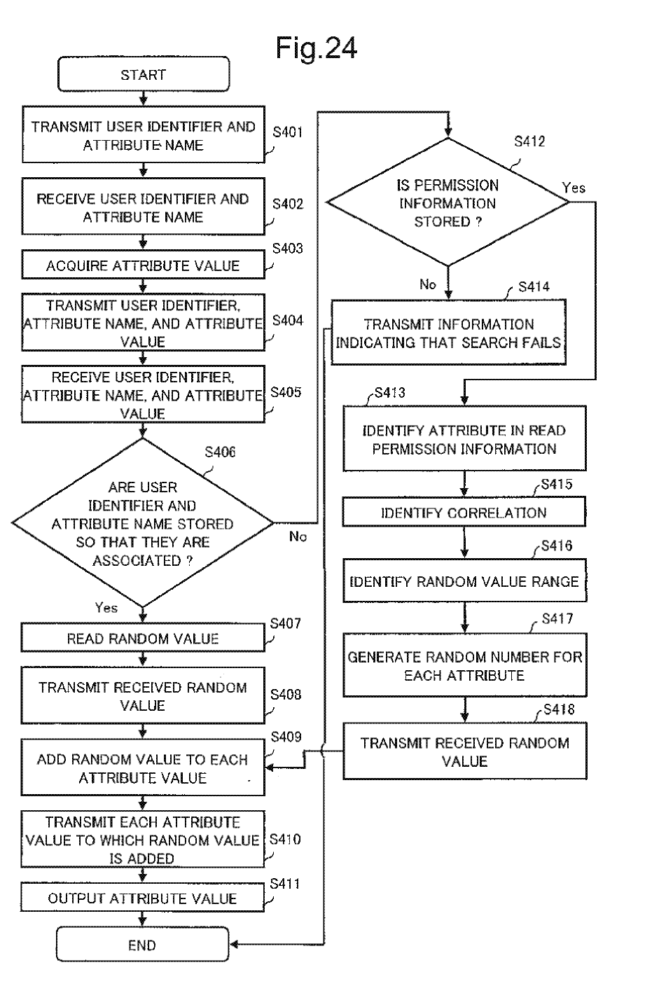

FIG. 24 is a flowchart showing an outline of operation of the random value identification system 40 according to the fourth exemplary embodiment. This example is an example in which the search provider device 430 transmits the user identifier and the attribute name to the information storing provider device 420a.

The search provider device 430 transmits the user identifier and the attribute name of the attribute of the information related to the user to the information storing provider device 420a (step S401). The reception unit 421 of the information storing provider device 420a receives the user identifier and the attribute name from the search provider device 430 (step S402). The reception unit 421 sends the user identifier and the attribute name which are received to the attribute value acquisition unit 422.

The attribute value acquisition unit 422 receives the user identifier and the attribute name from the reception unit 421. Then, the attribute value acquisition unit 422 acquires the attribute value associated with the user identifier and the attribute name which are received from the attribute value storage unit 211 (step S403). The attribute value acquisition unit 422 sends the acquired attribute value, the received user identifier, and the received attribute name to the transmission unit 423.

The transmission unit 423 receives the user identifier, the attribute name, and the attribute value from the attribute value acquisition unit 422, and transmits the user identifier, the attribute name, and the attribute value which are received to the random value identification device 400 (step S404).

The reception unit 401 of the random value identification device 400 receives the user identifier, the attribute name, and the attribute value from the information storing provider device 420a (step S405). Then, the reception unit 401 sends the user identifier, the attribute name, and the attribute value which are received to the search estimation unit 413.

The search estimation unit 413 judges whether or not the user identifier and the attribute name which are received by the reception unit 401 are stored in the random value storage unit 315 so that they are associated (step S406).

When the search estimation unit 413 judges that the user identifier and the attribute name are stored in the random value storage unit 315 so that they are associated (“Yes” in step S406), it performs the following process. Namely, the search estimation unit 413 reads the random value associated with the user identifier and the attribute name from the random value storage unit 315, and sends it to the random number transmission unit 408 (step S407).

The random number transmission unit 408 receives the random value generated by the random number generation unit 205 or the random value read from the random value storage unit 315 by the search estimation unit 413. The random number transmission unit 408 transmits the received random value to the information storing provider device 420a (step S408).

The random number addition unit 424 of the information storing provider device 420a receives the random value from the random value identification device 400. The random number addition unit 424 adds the random value of the attribute corresponding to the attribute value to the attribute value acquired by the attribute value acquisition unit 422 (step S409).

The random number addition unit 424 transmits the attribute value to which the random value is added to the search provider device 430 (step S410). When the search provider device 430 receives the attribute value to which the random value is added, it outputs the received attribute value (step S411). Then, the process of the random value identification system 40 ends.

On the other hand, when the search estimation unit 413 judges that the user identifier and the attribute name are not stored in the random value storage unit 315 so that they are associated (“No” in step S406), it performs the following process. Namely, the search estimation unit 413 judges whether or not the permission information associated with the user identifier is stored in the permission information storage unit 314 based on the user identifier received by the reception unit 401 (step S412).

When the search estimation unit 413 judges that the permission information is stored (“Yes” in step S412), it reads the permission information from the permission information storage unit 314. Then, the search estimation unit 413 identifies at least one attribute in the read permission information (step S413). Then, the process of the random value identification system 40 proceeds to step S415.

On the other hand, when the search estimation unit 413 judges that the permission information is not stored (“No” in step S412), it transmits information indicating that the search fails to the information storing provider device 420a. The information storing provider device 420a transmits the information indicating that the search fails to the search provider device 430 (step S414). Then, the process of the random value identification system 40 ends.

When the search estimation unit 413 identifies at least one attribute in the permission information read in step S413, it sends the user identifier, the attribute name, the attribute value, and the search range which are received by the reception unit 401 to the correlation identification unit 402. The correlation identification unit 402 identifies the correlation between the attributes indicated by the attribute name received by the reception unit 401 (step S415).

The random value range identification unit 404 identifies the random value range which is a range in which the random number can be taken between the attributes based on the attribute value received by the reception unit 401 and the correlation between the attributes identified by the correlation identification unit 402 (step S416). The random number generation unit 205 generates the random number for each corresponding attribute so that the random value is included in the random value range identified by the random value range identification unit 404 (step S417).

The random number transmission unit 408 receives the random value corresponding to each attribute generated by the random number generation unit 205. The random number transmission unit 408 transmits the received random value to the information storing provider device 420a (step S419). Then, the process of the random value identification system 40 proceeds to step S409.

The random value identification system 40 according to the fourth exemplary embodiment includes similar elements of the random value identification system 30 according to the third exemplary embodiment. Accordingly, the random value identification system 40 according to the first modification example of the fourth exemplary embodiment has a similar effect of the random value identification system 30 according to the third exemplary embodiment.

And, the random value identification device 400 according to the fourth exemplary embodiment identifies the random value range based on the value of the encrypted attribute value without knowing a true value of the attribute value. By using the fully homomorphic encryption as an encryption algorithm, the random value identification device 400 can perform the addition and the multiplication to the encrypted data without knowing the plain text and the secret key used for the encryption.

The random value identified based on the random value range which is identified by the random value identification device 400 is transmitted to the information storing provider device 420. Then, the information storing provider device 420 adds the encrypted random value to the encrypted attribute value as it is. The information storing provider device 420 transmits the encrypted attribute value to which the random value is added to the search provider device 430.

The search provider device 430 decodes the received attribute value by using the secret key generated by the search provider device 430, and outputs the decoded attribute value.

Accordingly, the random value identification system 40 according to the fourth exemplary embodiment can identify an appropriate random value which can conceal the value of the original data and can increase a validity of the data after adding the random value. In particular, the random value identification device 400 which identifies the random value range can identifies the appropriate random value which can increase a validity of the data after adding the random value without knowing the value of the original data.

An example of the effect of the present invention is to be able to identify an appropriate random value by which the value of original data can be concealed and the validity of data after adding the random value can be increased.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

And, each element according to each exemplary embodiment of the present invention can be realized by a computer and a program as well as hardware realization of functions. The program is provided by recording in a computer-readable recording medium such as a magnetic disc, a semiconductor memory, or the like, and is read to computer at the time of booting or the like. This read program controls the operation of the computer and makes the computer function elements according to each exemplary embodiment mentioned above.

This application is based upon and claims the benefit of priority from Japanese patent application No. 2011-047928, filed on Mar. 4, 2011, the disclosure of which is incorporated herein in its entirety by reference.

### INDUSTRIALLY APPLICATION

The random value identification device of the present invention can be applied to an information processing device which realizes privacy protection data mining.

### DESCRIPTION OF SYMBOL

20, 20a, 20b, 30, 30a, and 40 random value identification system
100, 200, 200a, 300, 300a, and 400 random value identification device
101, 201, 201a, 201b, 301, and 401 reception unit
102, 202, 302, and 402 correlation identification unit
103 and 203 attribute value acquisition unit
104, 204, and 404 random value range identification unit
105 and 205 random number generation unit
181a range information
181b range information
182 subspace
183 new subspace
184 original data
185 correlation
191 CPU
192 communication interface
193 memory
194 storage device
195 input device
196 output device
197 bus
198 recording medium
207 correlation storage unit
211 attribute value storage unit
212, 212b, and 312 random number addition unit
220, 320, 420, 420a, and 420b information storing provider device
221, 321, and 421 reception unit
230, 230a, 230b, and 430 search provider device
231 search reception unit
240 search request provider device
313 and 413 search estimation unit
314 permission information storage unit
315 random value storage unit
408 random number transmission unit
422 attribute value acquisition unit
423 transmission unit
424 random number addition unit

1. A random value identification device comprising:
a reception unit which receives an identifier which identifies a target and an attribute name of an attribute of information related to the target;
a correlation identification unit which identifies a correlation of the attribute indicated by the attribute name;
a attribute value acquisition unit which acquires at least one attribute value of the attribute of the target identified by the identifier; and
a random number generation unit which generates a random number for each the attribute in a random value range identified based on the acquired attribute value and the identified correlation.

2. The random value identification device according to claim 1, comprising:
correlation storage unit which stores a correlation of the attribute; and wherein
said correlation identification unit reads the correlation from said correlation storage unit based on the attribute and identifies the correlation between the attributes.

3. The random value identification device according to claim 1, comprising:
a random value range identification unit which stores range information indicating a range for each attribute, and identifying the random value range based on the range information, the acquired attribute value, and the identified correlation.

4. The random value identification device according to claim 3, wherein
said random value range identification unit identifies the random value range based on a differential value of a function corresponding to the correlation of the attribute.

5. The random value identification device according to claim 4, wherein
said random value range identification unit identifies the random value range based on the differential value of the function whose distance from the acquired attribute value is the smallest among the functions corresponding to the correlation.

6. The random value identification device according to claim 4, wherein
said random value range identification unit updates the value of the stored range information based on the distance between the acquired attribute value, and the function corresponding to the correlation and identifies the random value range based on the updated range information.

7. The random value identification device according to claim 2, wherein
said correlation identification unit calculates the correlation between the attributes based on the attribute value corresponding to the target, and stores the calculated correlation in said correlation storage unit.

8. The random value identification device according to claim 7, wherein
said correlation identification unit calculates the correlation based on the attribute value having a predetermined value.

9. The random value identification device according to claim 3, wherein
said reception unit receives area information indicating a range of the attribute value, and
said random value range identification unit generates the range information based on the area information.

10. The random value identification device according to claim 1, comprising:
an attribute value storage unit which stores the identifier, the attribute name, and the attribute value so that they are associated; and
a random number addition unit which receives a random number from said random value identification unit for each attribute, acquiring the attribute value associated with the identifier which is received from said attribute value storage unit by said reception unit and the attribute name corresponding to the attribute, and add the random number to the attribute value; and
said attribute value acquisition unit acquires at least one attribute value which is associated with the identifier received from said attribute value storage unit by said reception unit and the attribute name received by said reception unit.

11. The random value identification device according to claim 10 comprising:
a permission information storage unit which stores the identifier and permission information indicating the attribute of which the target identified by the identifier permits a disclosure so that they are associated;
a search estimation unit which reads the permission information associated with the identifier from said permission information storage unit based on the identifier received by said reception unit, and identifying at least one attribute in the read permission information; and
a random value storage unit which stores the identifier, the attribute name, and the random value so that they are associated; and
said correlation identification unit identifies the correlation between the attribute indicated by the attribute name received by said reception unit and the attribute identified by said search estimation unit.

12. A random value identification system comprising:
a search provider device; an information storing provider device; and a random value identification device; wherein
said search provider device comprising:
a query transmission unit which transmits an identifier which identifies a target and an attribute name of an attribute of information related to the target to said information storing provider device;
said information storing provider device comprising:
a reception unit which receives the identifier and the attribute name from said search provider device;
an attribute value storage unit which stores the identifier, the attribute name, and an attribute value so that they are associated;
an attribute value acquisition unit which acquires the attribute value associated with the identifier and the attribute name from said attribute value storage unit;
a transmission unit which transmits the identifier, the attribute name, and the attribute value to said random value identification device; and
a random number addition unit which receives the random value from said random value identification device for each attribute, acquiring the attribute value associated with the identifier received from said attribute value storage unit by said reception unit and the attribute name indicating the attribute, and adding the random number to the attribute value: and
said random value identification device comprising:
a reception unit which receives the identifier, the attribute name, and the attribute value from said information storing provider device;
a permission information storage unit which stores the identifier and permission information indicating the attribute of which the target identified by the identifier permits a disclosure so that they are associated;
a search estimation unit which reads the permission information associated with the identifier from said permission information storage unit based on the identifier received by said reception unit, and identifying at least one attribute from the attribute indicated by the read permission information;
a correlation identification unit which identifies the correlation between the identified attribute and the attribute indicated by the attribute name received by said reception unit;
a random number generation unit which generates the random number for each the attribute in the random value range identified based on at least one attribute value among the attribute values received by said reception unit and the identified correlation; and
a random number transmission unit which transmits the random number to said information storing provider device.

13. A random value identification system comprising:
the random value identification device according to claim 1; and
a search provider device which transmits the identifier and the attribute name to said random value identification device.

14. The random value identification system according to claim 12, comprising:
a search request provider device which transmits area information indicating a range of the attribute value to said search provider device; and
said search request provider device identifies the attribute name corresponding to the attribute value indicated by the area information when it receives the area information from said search request provider device, and transmits the identified attribute name and the identifier to said information storing provider device.

15. A random value identification method comprising:
receiving an identifier which identifies a target and an attribute name of an attribute of information related to the target;
identifying a correlation between the attributes;
acquiring at least one attribute value of the attribute of the target identified by the identifier; and
generating a random number for each the attribute in a random value range identified based on the acquired attribute value and the identified correlation.

16. A random value identification method comprising:
a search provider device transmits an identifier which identifies a target and an attribute name of an attribute of information related to the target to an information storing provider device;
said information storing provider device
receives the identifier and the attribute name from said search provider device,
stores the identifier by which the target can be identified, the attribute name, and an attribute value so that they are associated in attribute value storage unit,
acquires the attribute value associated with the identifier and the attribute name from said attribute value storage unit,
transmits the identifier, the attribute name, and the attribute value to a random value identification device,
receives the random value from said random value identification device for each attribute, acquires the attribute value associated with the identifier and the attribute name received from said attribute value storage unit, and adds the random number to the attribute value; and
said random value identification device
receives the identifier, the attribute name, and the attribute value from said information storing provider device,
stores the identifier and permission information indicating the attribute of which the target identified by the identifier permits a disclosure so that they are associated in permission information storage unit,
reads the permission information associated with the identifier from said permission information storage unit based on said received identifier, and identifies at least one attribute in the read permission information,
stores the identifier, the attribute name, and the random value so that they are associated in random value storage unit,
identifies the correlation between the attribute indicated by the attribute name received from said information storing provider device and said at least one identified attribute,
generates the random number for each said attribute in a random value range identified based on at least one attribute value among said received attribute values and said identified correlation, and
transmits the generated random number to said information storing provider device.

17. A computer readable medium embodying a program, said program causing a random value identification device to perform a method, said method comprising:
receiving an identifier which identifies a target and an attribute name of an attribute of information related to the target;
identifying a correlation between the attributes indicated by the attribute name;
acquiring at least one attribute value of the attribute of the target identified by the identifier; and
generating a random number for each the attribute in a random value range identified based on the acquired attribute value and the identified correlation.

18. The random value identification device according to claim 1, wherein the target is a user.

19. A random value identification device comprising:
reception means for receiving a user identifier and an attribute name of an attribute of information related to the user;
correlation identification means for identifying a correlation of the attribute indicated by the attribute name;
attribute value acquisition means for acquiring at least one attribute value of the attribute of the user identified by the user identifier; and
random number generation means for generating a random number for each the attribute in a random value range identified based on the acquired attribute value and the identified correlation.
